(19) United States
(12) Patent Application Publication
(10) Pub. No.: US 2024/0162487 A1
(43) Pub. Date: May 16, 2024

(54) NOVEL ANION RECEPTOR AND ELECTROLYTE COMPRISING SAME

(71) Applicant: ZAIN ENERGY INC., Cheongiu-si, Chungcheongbuk-do (KR)

(72) Inventor: Ju Young LEE, Daejeon (KR)

(21) Appl. No.: 18/278,006

(22) PCT Filed: Nov. 26, 2021
(86) PCT No.: PCT/KR2021/017668

§ 371 Date: Aug. 21, 2023

(30) Foreign Application Priority Data
Feb. 22, 2021 (KR) 10-2021-0023360
Nov. 1, 2021 (KR) 10-2021-0148224

(51) Int. Cl. H01M 10/0565; C07F 7/08; C07F 7/10; H01M 10/54

(52) U.S. Cl. CPC H01M 10/0565; C07F 7/0829; C07F 7/10; H01M 10/54; H01M 2300/0082

(57) ABSTRACT

The present disclosure relates to a novel anion receptor and an electrolyte including the same. More particularly, the present disclosure relates to a compound as a novel anion receptor, an electrolyte composition including the same compound, and an electrolyte including the same compound. The present disclosure also relates to a battery using the electrolyte and to a recycle battery using the electrolyte.

### TECHNICAL FIELD

The present disclosure relates to a novel anion receptor and an electrolyte comprising same.

### BACKGROUND ART

Anion receptors improve anion stability by the interaction between a Lewis acid and a Lewis base. Such anion receptors are compounds with electron-poor atoms (N, B). The anion receptors have a structure in which electron-rich anions are placed at the periphery to inhibit ion-pairing of anions and lithium cations, thereby facilitating the movement of the lithium cations. The first compound known as the anion receptor was aza-ether composed of cyclic or linear amides that render the nitrogen atom of the amine group having a perfluoroalkylsulfonyl substituent electron-deficient so that the nitrogen atom can properly interact with electron-rich anions through Coulomb attraction (refer to J. Electrochem. Soc., 143 (1996) 3825, 146 (2000) 9). However, these aza-ethers show limited solubility in polar solvents employed as typical non-aqueous electrolytes, and the electrochemical stability window of the electrolytes added with LiCl salt cannot satisfy 4.0 V required for commercial cathode materials. In addition, it was also found that aza-ethers are unstable in LiPF₆ (J. Electrochem. Solid-State Lett, 5 (2002) A248). In other words, LiPF₆ is chemically and thermally unstable, so that even at room temperature it equilibrates as a solid LiF and gaseous PF₅, and the generation of the gaseous product, PF₅, tilts the equilibrium toward the promotion of the generation of PF₅.

LiPF₆(s) [symbol] LiF(s)+PF₅(g)

In non-aqueous solvents, PF₅ tends to initiate a series of reactions such as ring-opening polymerization and breaking ether bonds composed of atoms with no-covalent electron pairs, such as oxygen or nitrogen. PF₅, which is a strong Lewis acid, attacks electron pairs, and the aza-ethers are immediately attacked by PF5 because of their large electron density (refer to J. Power Sources, 104 (2002) 260). This imposes significant limitations on the commercialization of aza-ether compounds. Due to these limitations, McBreen et al. synthesized an anion receptor by selecting a boron atom as an electron-poor element to be substituted by an electron withdrawing functional group (J. Electrochem. Soc., 145 (1998) 2813, 149 (2002) A1460).

Meanwhile, solid polymer electrolytes are convenient to use due to no risk of leakage and due to tolerance to vibration and shock, have low self-discharge characteristics, and can be used at high temperatures, so that solid polymer electrolytes are desirable when considering the trend of lightweight and miniaturization of portable electronic devices and the wireless trend of information and communication devices and home appliances. In addition, solid polymer electrolytes can be widely applied to large-capacity lithium polymer rechargeable batteries used in electric vehicles. For these reasons, many studies have been conducted to improve the performance of solid polymer electrolytes. A polyalkylene oxide (PAO)-based solid polymer electrolyte was first discovered by P. V. Wright in 1975 (British Polymer Journal, 7, 319), and was named “ionic conductive polymer” by M. Armand in 1978. A typical solid polymer electrolyte consists of a polymer with electron donating atoms such as oxygen, nitrogen, phosphorus, etc. along with a lithium salt complex. The most representative solid polymer electrolytes known to date are polyethylene oxide (PEO) and its lithium salt complex. However, since these electrolytes have a low ionic conductivity of about 10⁻⁸ S/cm at room temperature, they cannot be applied to electrochemical devices operating at room temperature. These PAO-based solid polymer electrolytes have high crystallinity which limits the movement of molecular chains, so the PAO-based solid polymer electrolytes have very low ionic conductivity at room temperature. In order to increase molecular chain mobility, it is necessary to minimize the crystalline region present in the polymer structure and increase the amorphous region. To this end, research has been conducted to use siloxane (Macromol. Chem. Rapid Commun., 7 (1986) 115) or phosphazene, having a flexible molecular chain as a main chain (J. Am. Chem. Soc., 106 (1984) 6845) or to use PAO having a relatively short molecular length, as a side chain (Electrochem. Acta, 34 (1989) 635). In addition, research has been conducted on a method of preparing reticulate solid polymer electrolytes by introducing one or more crosslinkable functional groups at the terminals of PAO, but their ionic conductivity at room temperature is about 10⁻⁵ to 10⁻⁴ S/cm. Therefore, these electrolytes are not suitable for use in lithium batteries, and ongoing research is being conducted to solve the problems. To solve this problem, Abraham et al. inserted polyethylene oxide with a low molecular weight into vinylidene hexafluoride-hexafluoropropene copolymer and confirmed that the ionic conductivity was improved (Chem. Mater., 9 (1997) 1978). In addition, by adding low molecular weight polyethylene glycol dimethyl ether (PEGDME) to a photocurable crosslinker having PEO as a side branch and siloxane as the main chain, an ionic conductivity of up to 8×10⁻⁴ S/cm at room temperature was achieved under film formation conditions (J. Power Sources 119-121 (2003) 448). However, the calculated cycling efficiency on an Ni electrode was about 53%. This low efficiency is attributed to a phenomenon in which lithium ions generated due to the corrosion of the surface of a newly deposited lithium layer passivate the surface of an electrode (Solid State Ionics 119 (1999) 205, Solid State Ionics 135 (2000) 283). In other words, according to Vincent, a reaction between a lithium salt and a lithium metal occurs (Solid State Chem. 17 (1987) 145),

LiSO₃CF₃+Li(s)→2Li⁺+SO₃²⁻+CF₃·

CF₃ radicals generated by the reaction detach hydrogen atoms from the PEO polymer chain and react with the hydrogen atoms to form HCF₃, and the main chain of the polymer is cleaved from the resulting ═COC— functional group. In this case, CH₃ radicals generated by the chain cleavage and CF₃ radicals attack the chains or break the —CO— bond, so that a Li—OR type compound attaches to the surface of an electrode, thereby forming a passivation film on the surface.

Therefore, in order to solve the problems described above, research on a new material capable of improving ionic conductivity and removing electrochemical instability and instability with respect to lithium salts. For example, it is possible to design a compound having a structure that does not have a nitrogen atom that is prone to attack in the middle of the conjugate, such as aza-ether, or to replace a PAO-based plasticizer.

### DISCLOSURE

### Technical Problem

In order to solve the problems described above, the present disclosure provides a compound serving as a novel silicon-based anion acceptor formed by introducing an amine group containing an electron withdrawing functional group as a substituent into a silicon atom or introducing an electron withdrawing functional group into a nitrogen atom in a ring.

The present disclosure is to provide an electrolyte composition that contains the novel silicon-based anion acceptor compound according to the present disclosure, which can improve the ionic conductivity and cationic transport rate in an electrolyte, which can increase the electrochemical stability of a battery (e.g., a primary battery or a secondary battery) using the electrolyte, and which can provide a liquid-type, gel-type, or solid electrolyte.

The present disclosure is to provide an electrolyte containing the novel silicon-based anion receptor compound according to the present disclosure and having significantly improved ionic conductivity and electrochemical stability at room temperature.

The present disclosure is to provide a solidifying electrolyte that contains the novel silicon-based anion receptor compound according to the present disclosure and which rapidly hardens when reaching or exceeding a certain temperature (e.g., about 130° C.) to stop the operation of a battery including the electrolyte, and which prevents fire caused by thermal runaway of a battery.

The present disclosure is to provide a polymer electrolyte membrane manufactured using the electrolyte composition according to the present disclosure.

The present disclosure is to provide a battery containing the electrolyte according to the present disclosure.

The present disclosure is to provide a recycle battery manufactured from components of waste batteries and the electrolyte according to the present disclosure.

The problems to be solved by the present disclosure are not limited to the ones mentioned above, and other problems that can be solved by the present disclosure can be clearly understood by those skilled in the art from the following description.

### Technical Solution

One embodiment of the present disclosure relates to a compound that is a novel anion receptor and represented by any one of Formulas 1 to 3 shown below.

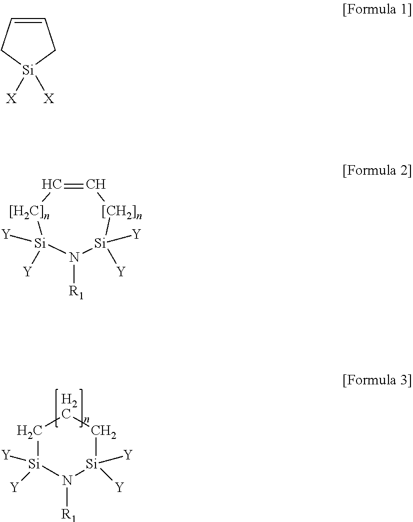

(In Formula 1,

X is selected from

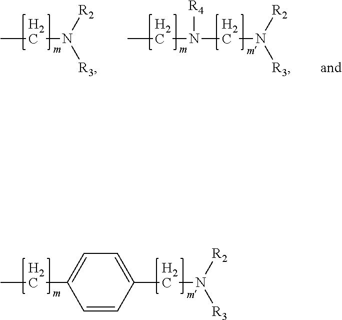

(R₂, R₃, and R₄ are each selected from a hydrogen atom, a halogen atom, and an electron withdrawing functional group that is selected from —SO₂CF₃, —COCF₃, —SO₂CN, —CF₃, and —CN; m and m′ are each independently an integer in a range of from 0 to 20; there is no case where R₂, R₃, and R₄ are all a hydrogen atom at the same time),

Y is selected from a hydrogen atom, a halogen atom, linear or branched alkyl groups having 1 to 20 carbon atoms, linear or branched alkenyl groups having 2 to 20 carbon atoms, linear or branched alkynyl groups having 2 to 20 carbon atoms, —COR (R is a linear or branched alkyl group having 1 to 20 carbon atoms or a linear or branched alkenyl group having 2 to 20 carbon atoms), —OR (R is a linear or branched alkyl group having 1 to 20 carbon atoms), —ROR′ (R and R′ are each independently a linear or branched alkyl group having 1 to 20 carbon atoms), —Si(R)₃ (R is a linear or branched alkyl group having 1 to 20 carbon atoms), —O—Si(R)₃ (R is a linear or branched alkyl group having 1 to 20 carbon atoms),

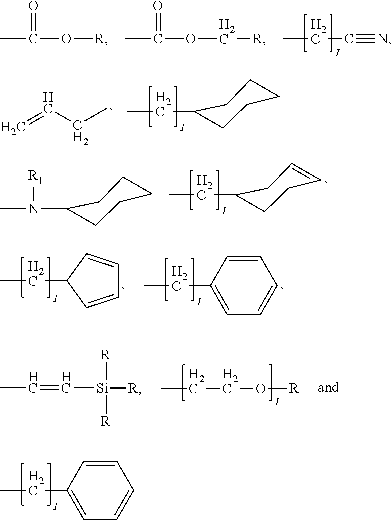

(R is selected from linear or branched alkyl groups having 1 to 20 carbon atoms and linear or branched alkenyl groups having 2 to 20 carbon atoms; R₁ is selected from a halogen atom and an electron withdrawing functional group that is selected from —SO₂CF₃, —COCF₃, —SO₂CN, —CF₃, and —CN; and 1 is an integer in a range of from 0 to 20),

R₁ is selected from a halogen atom and an electron withdrawing functional group that is selected from —SO₂CF₃, —COCF₃, —SO₂CN, —CF₃, and —CN, and

n is an integer in a range of from 0 to 20).

One embodiment of the present disclosure relates to an electrolyte composition containing an anion receptor including at least one of the compounds represented by Formulas 1 to 3 according to the present disclosure.

According to one embodiment of the present disclosure, the anion receptor may further include at least one of the compounds represented by Formulas 4 to 13 shown below.

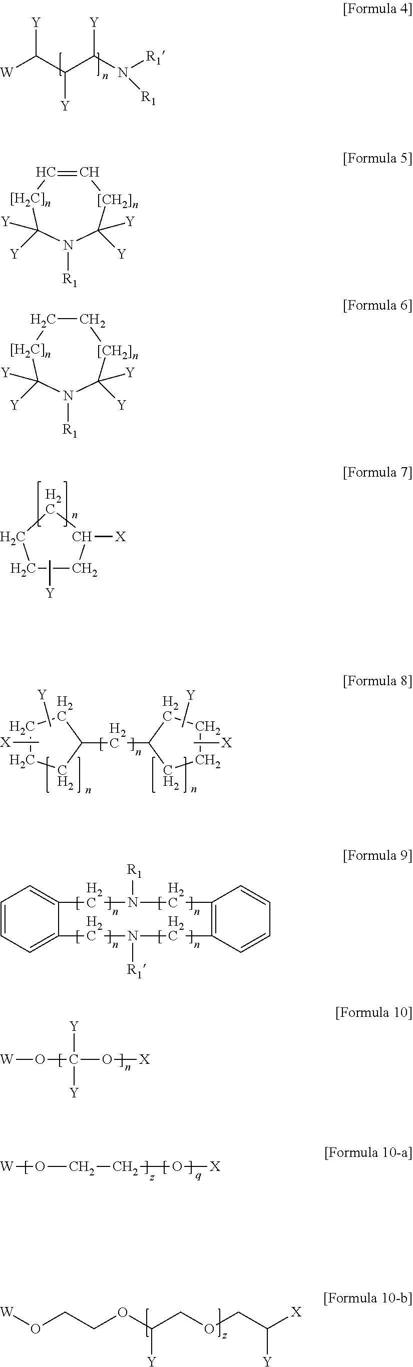

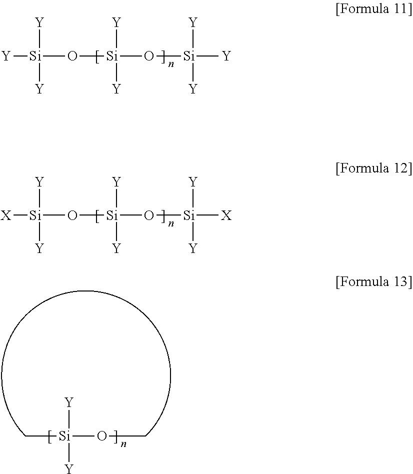

(In Chemical Formulas 4 to 13,

X is selected from

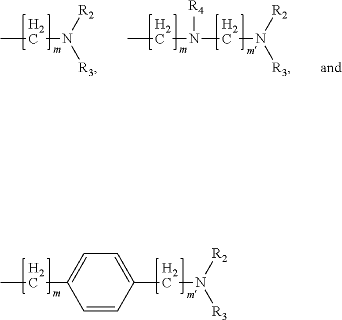

(R₂, R₃, and R₄ are each selected from a hydrogen atom, a halogen atom, and an electron withdrawing functional group that is selected from —SO₂CF₃, —COCF₃, —SO₂CN, —CF₃, and —CN; m and m′ are each independently an integer in a range of from 0 to 20; and there is no case where R₂, R₃, and R₄ are all a hydrogen atom at the same time),

Y is selected from a hydrogen atom, a halogen atom, linear or branched alkyl groups having 1 to 20 carbon atoms, linear or branched alkenyl groups having 2 to 20 carbon atoms, linear or branched alkynyl groups having 2 to 20 carbon atoms, —COR (R is a linear or branched alkyl group having 1 to 20 carbon atoms or a linear or branched alkenyl group having 2 to 20 carbon atoms), —OR (R is a linear or branched alkyl group having 1 to 20 carbon atoms), —ROR′ (R and R′ are each independently a linear or branched alkyl group having 1 to 20 carbon atoms), —Si(R)₃ (R is a linear or branched alkyl group having 1 to 20 carbon atoms), —O—Si(R)₃ (R is a linear or branched alkyl group having 1 to 20 carbon atoms),

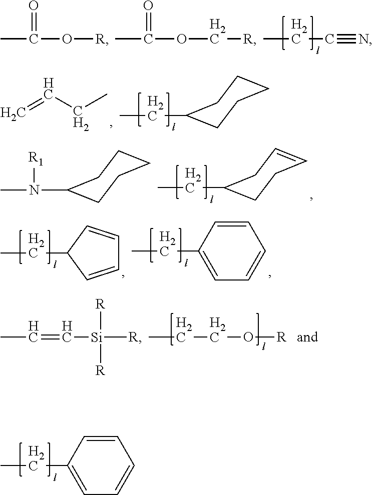

(R and R₁ are each selected from linear or branched alkyl groups having 1 to 20 carbon atoms and linear or branched alkenyl groups having 2 to 20 carbon atoms; R₁ is selected from a halogen atom and an electron withdrawing functional group that is selected from —SO₂CF₃, —COCF₃, —SO₂CN, —CF₃, and —CN; and 1 is an integer in a range of from 0 to 20),

R₁ and R₁′ are each selected from a hydrogen atom and an electron withdrawing functional group that is selected from —SO₂CF₃, —COCF₃, —SO₂CN, —CF₃, and —CN, in which there is no case where R₁ and R₁′ are both a hydrogen atom at the same time in the same molecule,

W is selected from a hydrogen atom, a halogen atom, linear or branched alkyl groups having 1 to 20 carbon atoms, linear or branched alkenyl groups having 2 to 20 carbon atoms, linear or branched alkynyl groups having 2 to 20 carbon atoms,

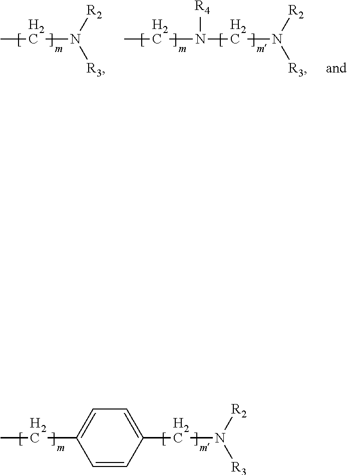

(R₂, R₃, and R₄ are each selected from a hydrogen atom, a halogen atom, and an electron withdrawing functional group that is selected from —SO₂CF₃, —COCF₃, —SO₂CN, —CF₃, and —CN; there is no case where R₂, R₃, and R₄ are all a hydrogen atom at the same time; and m and m′ are each independently an integer in a range of from 0 to 20),

z is an integer in a range of from 1 to 20,

n and q are each an integer in a range of from 0 to 20).

The present disclosure relates to an electrolyte prepared from the electrolyte composition according to the present disclosure.

The present disclosure relates to a solidifying electrolyte prepared from the electrolyte composition according to the present disclosure.

The present disclosure relates to a polymer electrolyte membrane prepared from the electrolyte composition according to the present disclosure.

One embodiment of the present disclosure relates a battery including an anode, a cathode, and an electrolyte made of the electrolyte composition according to the present disclosure.

One embodiment of the present disclosure relates a recycle battery including an anode recovered from a waste battery, a cathode recovered from a waste battery, and an electrolyte made of the electrolyte composition according to the present disclosure.

### Advantageous Effects

Embodiments of the present disclosure can provide a compound that is a novel silicon-based anion receptor, an electrolyte (e.g., non-aqueous liquid electrolyte) containing the compound, and a gel-type or solid electrolyte (e.g., gel-type polymer electrolyte or solid polymer electrolyte) containing the same. That is, the present disclosure can provide a novel cyclic silicon compound in which an amine group having an electron withdrawing functional group as a substituent is introduced into a silicon atom or an electron withdrawing functional group is introduced into a nitrogen atom in a ring. In addition, the present disclosure provides an electrolyte manufactured using the novel cyclic silicon compound, the electrolyte being an electrolyte (for example, gel-type or solid polymer electrolyte) having a variety of applications such as: small-capacity lithium polymer secondary batteries applied to mobile information terminals such as mobile phones and laptop computers and a variety of electronic devices such as camcorders; and large-capacity secondary batteries (e.g. lithium polymer secondary batteries) used in power storage devices for power leveling and in electric vehicles.

Embodiments of the present disclosure can provide a battery with significantly improved ionic conductivity and electrochemical stability by using a compound that is a novel silicon-based anion receptor, an electrolyte (e.g., non-aqueous liquid electrolyte) containing the compound, or a gel-type or solid electrolyte (e.g., gel-type polymer electrolyte or solid polymer electrolyte).

Embodiments of the present disclosure can provide a solidifying electrolyte that is improved in safety to lower the risk of fire attributable to thermal runaway and which is improved in usability so as to be applied to power storage devices as well as batteries for electric vehicles.

### BRIEF DESCRIPTION OF DRAWINGS

FIG. 1 is a graph showing comparison of low-temperature (−10° C.) battery performance (discharge capacity at low temperature according to the number of cycles) between an example according to one embodiment of the present disclosure and a comparative example through Experimental Example 11.

FIG. 2 is a graph showing comparison of battery performance (relative capacitance versus voltage) at high temperature (55° C.) and low temperature (−20° C.) between an example according to one embodiment of the present disclosure and a comparative example through Experimental Example 12.

FIG. 3a is an image taken before curing a solid electrolyte of Example 16 through Experimental Example 15 according to an embodiment of the present invention.

FIG. 3b is an image taken after curing a solid electrolyte of Example 16 through Experimental Example 15 according to an embodiment of the present invention.

### BEST MODE

Hereinafter, embodiments will be described in detail with reference to the accompanying drawings. However, various changes can be made to the embodiments, and thus the scope of the present disclosure is not limited or limited to the embodiments. It should be understood that all modifications, equivalents, and substitutes to the embodiments fall within the protection scope of the present disclosure.

The terms used to describe embodiments and examples are for illustrative purposes only and should not be construed as being restrictive. As used herein, the singular forms “a”, “an”, and “the” are intended to include plural forms as well unless the context clearly indicates otherwise. It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof.

Terms used in the specification, “first”, “second”, etc., may be used to describe various components, but the components are not to be construed as being limited to the terms. These terms are used only to distinguish one component from others. Accordingly, a first component in one embodiment may be referred to as a second component in another element, and similarly, a second component in an embodiment may be referred to as a first component in another embodiment without departing from the scope of the present disclosure determined in consistent with the concept of the embodiments.

Unless otherwise defined, all terms including technical and scientific terms used herein have the same meaning as commonly understood by those who are ordinarily skilled in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In addition, in describing the present disclosure with reference to the accompanying drawings, like components are denoted by like reference numerals through the drawings, and a redundant description thereof will be omitted. In the following description, when a detailed description of a related art is determined to unnecessarily obscure the gist of the present disclosure, the detailed description of the related art may be omitted.

Hereinafter, a novel anion receptor according to the present disclosure, a preparation method thereof, and uses thereof will be described in detail with reference to embodiments and drawings. However, the present disclosure is not limited to the embodiments and drawings.

The present disclosure relates to a novel anion receptor.

In one embodiment of the present disclosure, the anion receptor is a novel silicon-based compound in which an amine group having an electron withdrawing functional group as a substituent is introduced into a silicon atom or an electron withdrawing functional group is introduced into a nitrogen atom in a ring.

In one embodiment of the present disclosure, the anion receptor compound may include the compounds represented by Formulas 1 to 13 shown below. The compound can act as an anion acceptor in an electrolyte composition (e.g., electrolyte). When the compound is used as an additive to an electrolyte composition (e.g., electrolyte), the compound can improve ionic conductivity and cationic transport rate and thus increase the electrochemical stability of a battery using the electrolyte composition.

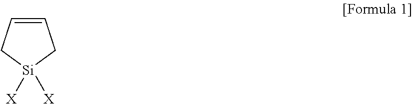

As an example of the present disclosure, the compound represented by Formula 1 may be a novel cyclic silicon compound in which an amine group having an electron withdrawing functional group as a substituent is introduced into silicon.

As an example of the present disclosure, in Formula 1, X may be selected from

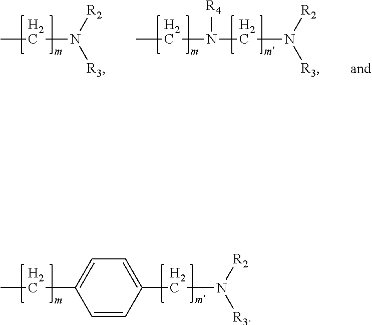

In X, R₂, R₃, and R₄ are each selected from a hydrogen atom, a halogen atom, and an electron withdrawing functional group that is selected from —SO₂CF₃, —COCF₃, —SO₂CN, —CF₃, and —CN. However, in one molecule or X, there is no case where R₂ and R₃ are both a hydrogen atom at the same time. In addition, there is no case where R₂, R₃, and R₄ are all a hydrogen atom at the same time, wherein at least one of R₂, R₃, and R₄ is an electron withdrawing functional group.

In X, m and m′ may each be an integer in a range of from 0 to 20. Alternatively, m and m′ may not be “0” at the same time within one molecule or X.

Preferably, R₂, R₃, and R₄ are each selected from a hydrogen atom, a halogen atom, and an electron withdrawing functional group that is selected from —SO₂CF₃, —COCF₃, and —CF₃; and m and m′ may each be an integer in a range of from 0 to 10. More preferably, R₂, R₃, and R₄ are each selected from a hydrogen atom, —F, —Cl, —SO₂, CF₃, and —COCF₃; and m and m′ are each an integer in a range of from 0 to 5.

As an example of the present disclosure, in Formula 1, n may be an integer in a range of from 0 to 20, and preferably n may be an integer in a range of from 0 to 10.

As an example of the present disclosure, the compound represented by Formula 1 may be selected from the following compounds:

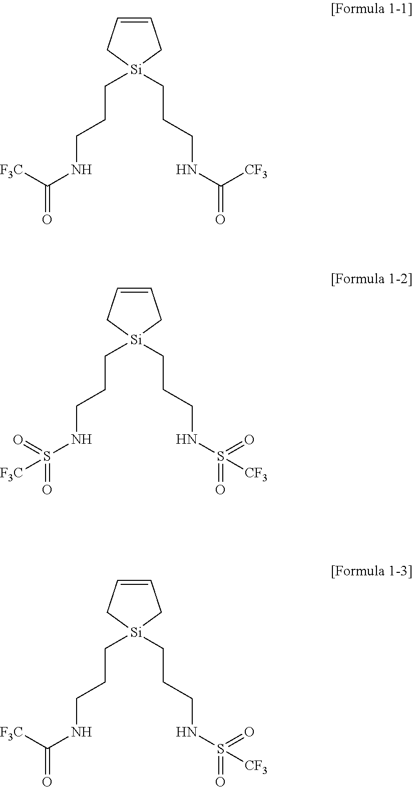 [SMILES: O=C(NCCC[Si]1(CCCNC(=O)C(F)(F)F)CC=CC1)C(F)(F)F ; O=S(=O)(NCCC[Si]1(CCCNS(=O)(=O)C(F)(F)F)CC=CC1)C(F)(F)F ; O=C(NCCC[Si]1(CCCNS(=O)(=O)C(F)(F)F)CC=CC1)C(F)(F)F]

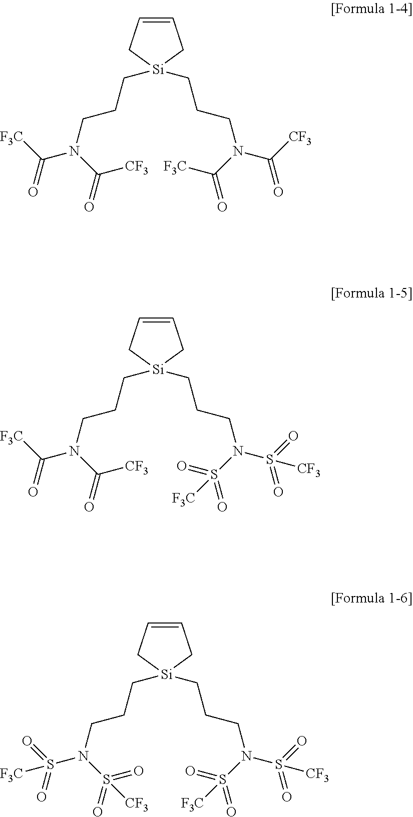 [SMILES: O=C(N(CCC[Si]1(CCCN(C(=O)C(F)(F)F)C(=O)C(F)(F)F)CC=CC1)C(=O)C(F)(F)F)C(F)(F)F ; O=C(N(CCC[Si]1(CCCN(S(=O)(=O)C(F)(F)F)S(=O)(=O)C(F)(F)F)CC=CC1)C(=O)C(F)(F)F)C(F)(F)F ; O=S(=O)(N(CCC[Si]1(CCCN(S(=O)(=O)C(F)(F)F)S(=O)(=O)C(F)(F)F)CC=CC1)S(=O)(=O)C(F)(F)F)C(F)(F)F]

According to one embodiment of the present disclosure, the compounds represented by Formula 2 and Formula 3 below may be novel cyclic silicon compounds in which an electron withdrawing functional group is introduced into a nitrogen atom in a ring.

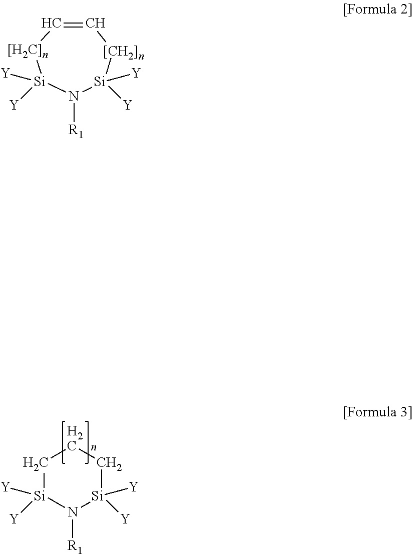

As an example of the present disclosure, in Formula 2 and Formula 3, R₁ is selected from a halogen atom and an electron withdrawing functional group that is selected from —SO₂CF₃, —COCF₃, —SO₂CN, —CF₃, and —CN. Preferably, R₁ is selected from —SO₂CF₃, —COCF₃, and —CF₃.

As an example of the present disclosure, in Formula 2 and Formula 3, Y is selected from a halogen atom, linear or branched alkyl groups having 1 to 20 carbon atoms, linear or branched alkenyl groups having 2 to 20 carbon atoms, linear or branched alkynyl groups having 2 to 20 carbon atoms, —COR, —OR, —ROR′, —Si(R)₃, —O—Si(R)₃,

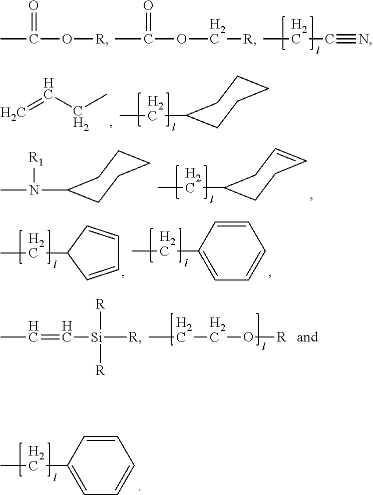

In Y, R, R′, and R₁ are each selected from a hydrogen atom, a halogen atom, linear or branched alkyl groups having 1 to 20 carbon atoms, linear or branched alkenyl groups having 2 to 20 carbon atoms, and electron withdrawing functional groups selected from —SO₂CF₃, —COCF₃, —SO₂CN, —CF₃, and —CN. Preferably, R and R′ are each selected from linear or branched alkyl groups having 1 to 20 carbon atoms and linear or branched alkenyl groups having 2 to 20 carbon atoms, and Ri is selected from a halogen atom and an electron withdrawing functional group that is selected from —SO₂CF₃, —COCF₃, —SO₂CN, —CF₃, and —CN. 1 may be an integer in a range of from 0 to 20.

Preferably in Y

R in “—COR” may be selected from linear or branched alkyl groups having 1 to 20 carbon atoms

and linear or branched alkenyl groups having 2 to 20 carbon atoms.

R in “—OR” may be a linear or branched alkyl group having 1 to 20 carbon atoms.

R and R′ in “—ROR′” may each be a linear or branched alkyl group having 1 to 20 carbon atoms.

R in “—Si(R)₃” may be a linear or branched alkyl group having 1 to 20 carbon atoms.

R in “—O—Si(R)₃” may be a linear or branched alkyl group having 1 to 20 carbon atoms.

I may be an integer in a range of from 0 to 10 or a range of from 0 to 5.

More preferably, in Formula 2 and Formula 3, Y may be selected from —F, —CH₃, —CH₂CH₃, —CH═CH₂, —CO—CH═CH₂, —OCH₃, —CH₂OCH₃, —OCH₂CH₃, —CH(CH₃)₂, —O—CH(CH₃)₂, —C(CH₃)₃, —Si(CH₃)₃, —O—Si(CH₃)₃,

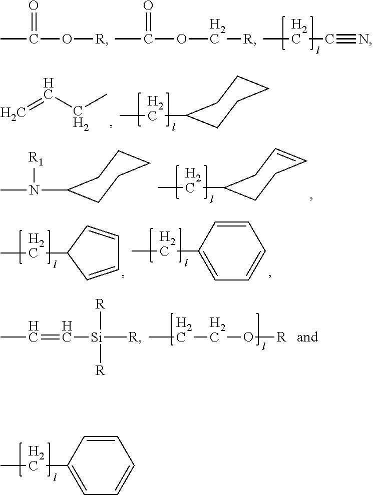

(R is selected from linear or branched alkyl groups having 1 to 5 carbon atoms, and is preferably —CH₃; and R₁ is selected from a halogen atom and an electron withdrawing functional group that is selected from —SO₂CF₃, —COCF₃, and —CF₃ and preferably selected from —F, —Cl, —SO₂CF₃, and —COCF₃; and 1 is an integer in a range of from 0 to 10 and preferably a range of from 0 to 3).

As an example of the present disclosure, in Formula 2 and Formula 3, n is an integer in a range of from 0 to 20, and preferably, n is an integer in a range of from 0 to 10.

As an example of the present disclosure, the compound represented by Formula 2 may be selected from the following compounds:

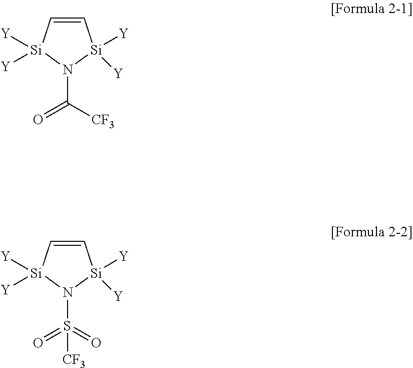

In Formula 2-1 and Formula 2-2, Y is selected from a halogen atom, linear or branched alkyl groups having 1 to 10 carbon atoms, and alkenyl groups having 2 to 10 carbon atoms, and preferably, Y is selected from —F, —CH₃, —CH₂CH₃, and —CH═CH₂, and is more preferably —CH₃.

As an example of the present disclosure, the compound represented by Formula 3 may be selected from the following compounds:

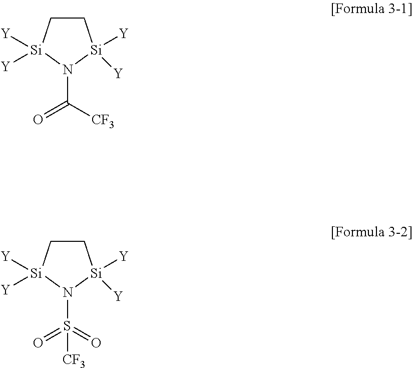

In Formula 3-1 and Formula 3-2, Y is selected from a halogen atom, linear or branched alkyl groups having 1 to 10 carbon atoms, and linear or branched alkenyl groups having 2 to 10 carbon atoms, is preferably selected from —F, —CH₃, —CH₂CH₃, and —CH═CH₂, and is more preferably —CH₃.

As an example of the present disclosure, the “halogen atom” may be selected from a fluorine atom, a chlorine atom, a bromine atom, and an iodine atom. Preferably, the halogen atom is selected from a fluorine atom and a chlorine atom. More preferably, the halogen atom is a fluorine atom.

As an example of the present disclosure, the “alkyl group” is linear or branched and has 1 to 20 carbon atoms, 1 to 15 carbon atoms, 1 to 10 carbon atoms, 1 to 5 carbon atoms, or 1 to 3 carbon atoms. For example, the alkyl group may be methyl, ethyl, propyl, isopropyl, isobutyl, tert-butyl, pentyl, hexyl, or the like.

As an example of the present disclosure, the “alkenyl group” is linear or branched and has 2 to 20 carbon atoms, 1 to 15 carbon atoms, 2 to 10 carbon atoms, 2 to 5 carbon atoms, or 2 to 3 carbon atoms. For example, the alkenyl group may be vinyl, propenyl, isopropenyl, butenyl, pentenyl, hexenyl, or the like.

As an example of the present disclosure, the “alkynyl group” is linear or branched and has 2 to 20 carbon atoms, 1 to 15 carbon atoms, 2 to 10 carbon atoms, 2 to 5 carbon atoms, or 2 to 3 carbon atoms. For example, the alkynyl group may be acetylenyl, propynyl, butynyl, fentinyl, hexynyl, or the like.

As an example of the present disclosure, “n” is an integer in a range of from 0 to 20, a range of from 0 to 15, a range of from 0 to 10, a range of from 0 to 5, a range of from 1 to 20, a range of from 1 to 15, a range of from 1 to 10, or a range of from 1 to 5.

As an example of the present disclosure, “m” and “m”' are each an integer in a range of from 0 to 20, a range of from 0 to 15, a range of from 0 to 10, a range of from 1 to 20, a range of from 0 to 10, a range of from 0 to 3, a range of from 1 to 15, a range of from 1 to 10, or a range of from 1 to 5.

As an example of the present disclosure, “1” is an integer in a range of from 0 to 20, a range of from 0 to 15, a range of 0 to 10, a range of 1 to 20, a range of from 0 to 10, a range of from 0 to 3, a range of from 1 to 15, a range of from 1 to 10, or a range of from 1 to 5.

According to an embodiment of the present disclosure, the anion receptor can be applied to an electrolyte composition described below, an electrochemical battery using the electrolyte composition, or a component of the electrochemical cell. According to one embodiment of the present disclosure, the electrolyte composition is applied by impregnation, coating, molding, etc., or the electrolyte composition is applied in the form of a liquid, gel, solid, or molded body (film, thin film, porous structure, sheet, etc.).

The present disclosure relates to a method of preparing the anion receptor of the present disclosure.

According to an embodiment of the present disclosure, the anion receptor preparation method is a method of producing a novel silicon compound, which is a compound represented by one of Formulas 1 to 3. As an example of the present disclosure, the compounds represented by Formulas 1 to 3 can be prepared according to the following reaction formula:

According to one embodiment of the present disclosure, in order to obtain an end product according to the chemical structural design, as starting materials, catalysts, solvents, reaction conditions, reaction mechanisms, and post-treatment processes (reactant separation, filtration, crystallization, washing, etc.), those known in the art to which the present disclosure pertains will be appropriately used. A single solvent or a solvent mixture selected from, for example, water, methanol, isopropanol, ethanol, methylene chloride, dichloromethane, acetonitrile, tetrahydrofuran, methyl-tert-butyl ether, chloroform, DMF, and N,N-dimethylacetamide may be used. The reaction temperature may be −40° C. or above, −10° C. or above, 0° C. or above, room temperature or above, 40° C. or above, 50° C. or above, 80° C. or above, 100° C. or above, or a range of −40° C. to 130° C. For example, the reaction temperature can be appropriately selected depending on the reflux conditions of the reaction mixture. Additionally, a catalyst such as a platinum catalyst, and a basic substance (triethylamine, diisopropylethylamine, pyridine, etc.) may be added.

According to one embodiment of the present disclosure, as shown in Reaction Formula 1-a below, an allyl compound in which a silicon compound represented by Formula 1-a and a nitrogen atom represented by Formula b are substituted with an electron withdrawing functional group such as —SO₂CF₃, —CN, —F, —Cl, —COCF₃, —SO₂CN, etc. undergoes a hydrosilylation reaction in the presence of a platinum catalyst in a solvent such as tetrahydrofuran to produce a compound represented by Formula 1-c.

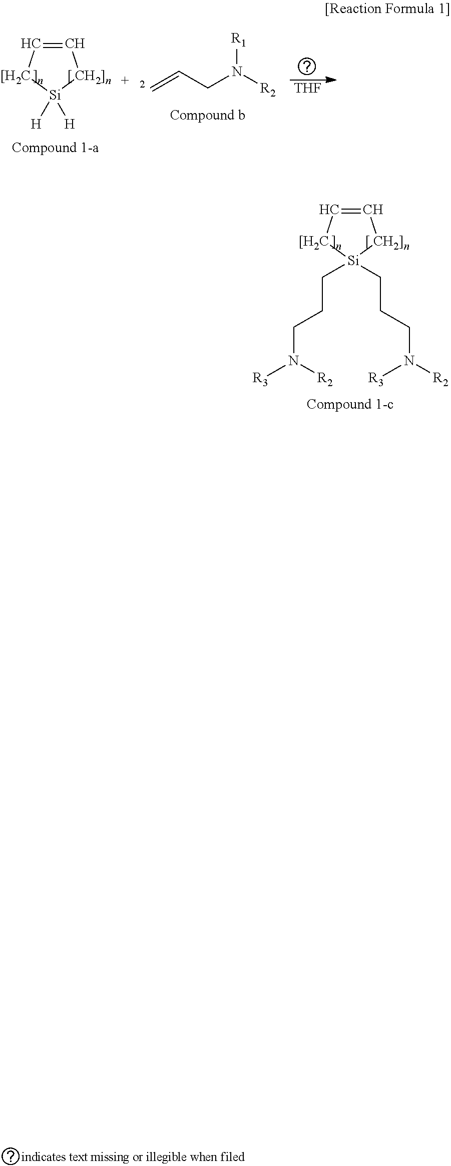

(In Reaction Formula 1, R₂, R₃, and n are each as defined in Formula 1 above.)

According to one embodiment of the present disclosure, as shown in Reaction Formulas 2-a-1 and 3-a-1 below, each of silicon compounds represented by Formula 2-a and 3-a and triflic anhydride [(CF₃SO₂)O] may be reacted in a triethylamine-added chloroform solvent to synthesize compounds represented by Formulas 2-c-1 and 3-c-1.

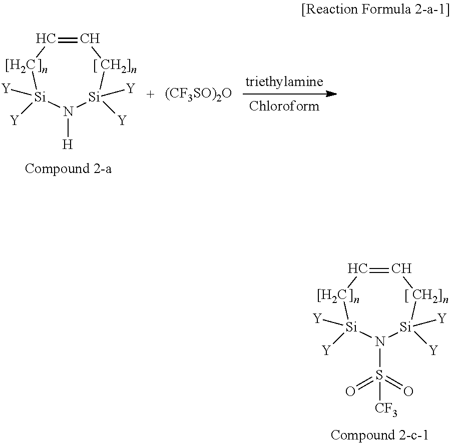

(In Reaction Formula 2-a-1, Y and n are each as defined in Formula 2 above.)

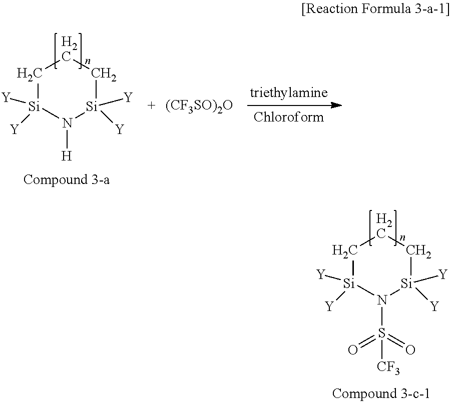

(In Reaction Formula 3-a-1, Y and n are each as defined in Formula 3 above.)

According to one embodiment of the present disclosure, as shown in Reaction Formulas 2-a-2 and 3-a-2, each of silicon compounds represented by Formulas 2-a and 3-a and ethyltrifluoroacetate [CF₃CO₂C₂H₅] may be reacted in a chloroform solvent to synthesize compounds represented by Formulas 2-c-2 and 3-c-2.

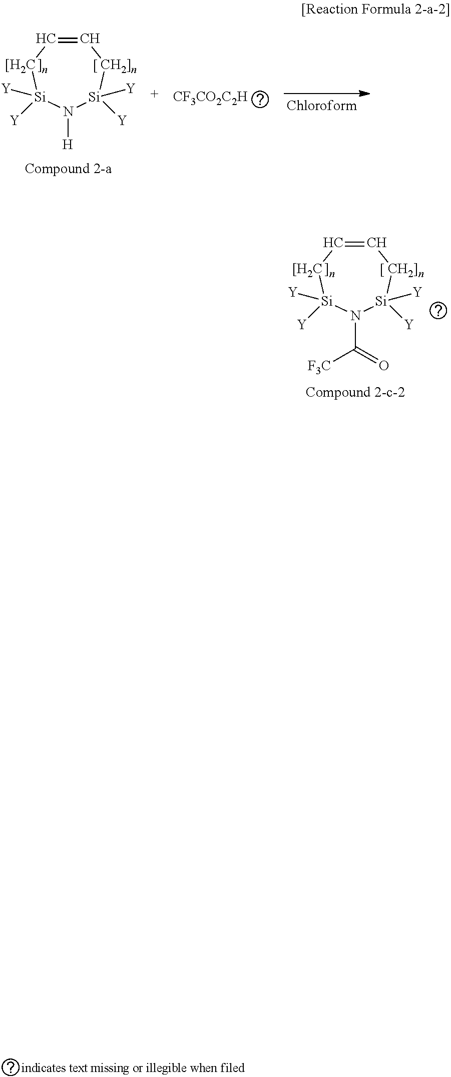

(In Reaction Formula 2-a-2, Y and n are each as defined in Formula 2 above.)

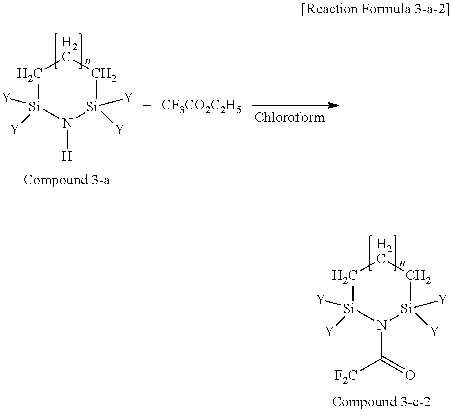

(In Reaction Formula 3-a-2, Y and n are each as defined in Formula 2 above.)

The present disclosure relates to an electrolyte composition containing the novel anion receptor of the present disclosure.

According to one embodiment of the present disclosure, the anion receptor may include at least one of the novel silicon compounds that are represented by Formulas 1 to 3 and in which an amine group having an electron withdrawing functional group as a substituent is introduced into a silicon atom, or an electron withdrawing functional group is introduced into a nitrogen atom in a ring.

According to one embodiment of the present disclosure, the electrolyte composition includes: the above-mentioned novel silicon compound; and at least one of a linear hydrocarbon compound represented by Formula 4, a cyclic hydrocarbon compound represented by Formula 5 to 9, a polyalkylene oxide compound represented by Formula 10, and a siloxane compound represented by Formula 11 to 13, in which each of the compounds has the nitrogen atom included in the amine group substituted with the electron withdrawing functional group. The electrolyte composition includes a mixture of the at least one compound among the above-mentioned compounds and the novel silicon compound.

That is, among the functional groups introduced as side chains, an amine group substituted with an electron withdrawing functional group or a nitrogen atom in a ring substituted with an electron withdrawing functional group promotes dissociation of alkali metal salts and thus increases electronegativity and cation mobility. For example, since an electron withdrawing functional group such as —SO₂CF₃, —CN, —F, —Cl, —COCF₃, —SO₂CN, etc. renders an amine group or a nitrogen atom in a ring an electron-poor state, it can form electrically neutral complexes with anionic species of alkali metal salts, thereby enhancing dissociation of alkali metal salts. In addition, since a hydrogen atom in an amine group forces the nitrogen atom having an electron withdrawing functional group as a substituent at the end of the a hydrocarbon chain, the problems of electrochemical instability caused by the presence of a nitrogen atom susceptible to attack in the middle of the conjugate, such as the aza-ether disclosed in U.S. Pat. Nos. 5,705,689 and 6,120,941, and the instability and steric hindrance of lithium salts (for example, LiPF₆) can be solved. In addition, since the nitrogen atom positioned at the center is more easily exposed, anions with large volumes can easily access the nitrogen atom. Therefore, dissociation of lithium salts is promoted, cation mobility is increased, and high ionic conductivity can be obtained.

As an example of the present disclosure, the compound of Formula 4 may function as an anion receptor in an electrolyte composition (or electrolyte).

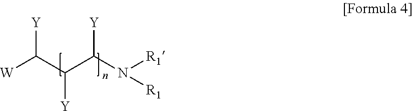

As an example of the present disclosure, in Formula 4, Y, X, and n are each as defined in Formula 1. In Formula 4, R₁ and R₁′ are each selected from a hydrogen atom, a halogen atom, and an electron withdrawing functional group that is selected from —SO₂CF₃, —COCF₃, —SO₂CN, —CF₃, and —CN, wherein there is no case that R₁and R₁′ are each a hydrogen atom at the same time in the same molecule, and at least one of R₁ and R₁′ is an electron withdrawing functional group.

As an example of the present disclosure, in Formula 4, W is selected from a hydrogen atom, a halogen atom, linear or branched alkyl groups having 1 to 20 carbon atoms, linear or branched alkenyl groups having 2 to 20 carbon atoms, linear or branched alkynyl groups having 2 to 20 carbon atoms,

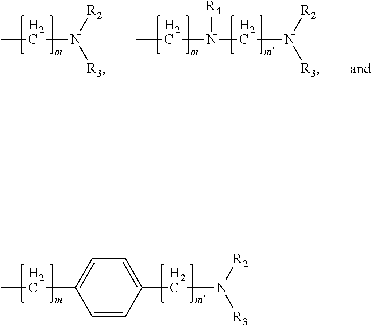

(R₂, R₃, and R₄ are each selected from a hydrogen atom, a halogen atom, and an electron withdrawing functional group that is selected from —SO₂CF₃, —COCF₃, —SO₂CN, —CF₃, and —CN; there is no case where R₂, R₃, and R₄ are all a hydrogen atom at the same time; and m and m′ are each independently an integer in a range of from 0 to 20).

As an example of the present disclosure, the compound represented by Formula 4 may be selected from the following compounds:

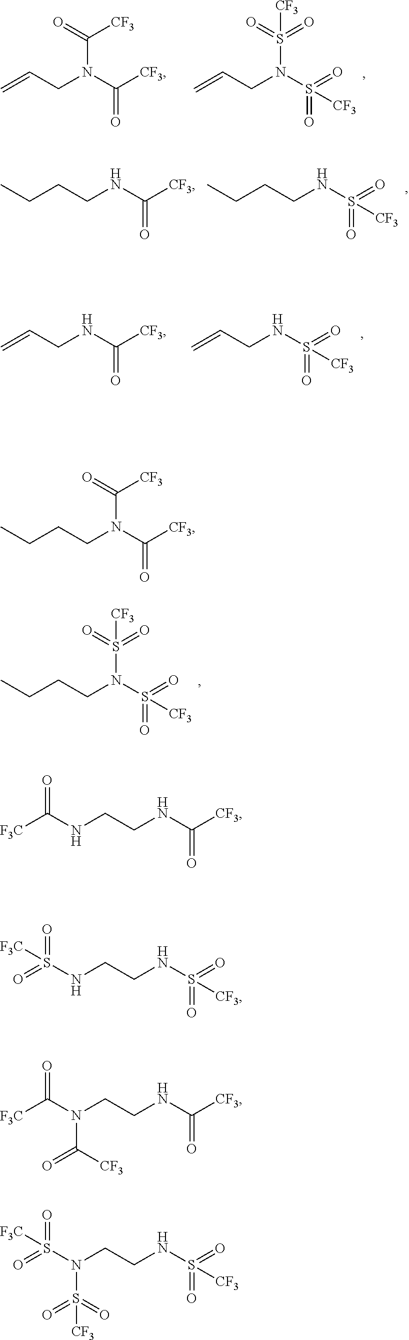

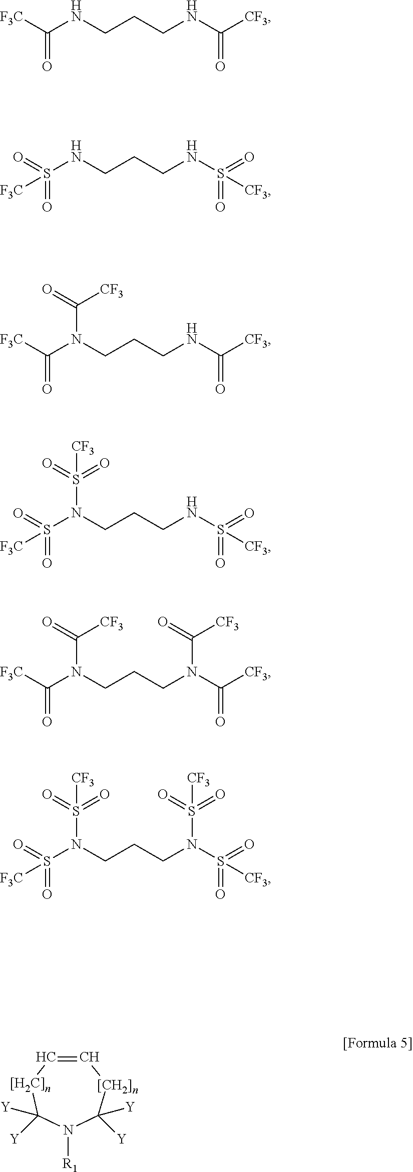

As an example of the present disclosure, the compound represented by Formula 5 may function as an anion receptor in an electrolyte composition (or electrolyte), and in Formula 5, Y, R₁ and n are the same as defined in Formula 1.

As an example of the present disclosure, the compound represented by Formula 5 may be selected from the following compounds:

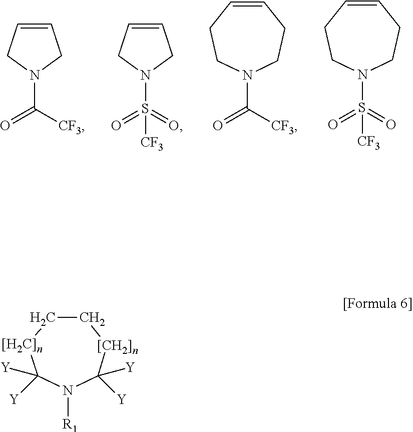

As an example of the present disclosure, the compound represented by Formula 6 may function as an anion receptor in an electrolyte composition (or electrolyte), and in Formula 6, Y, R₁ and n are the same as defined in Formula 1.

As an example of the present disclosure, the compound represented by Formula 6 may be selected from the following compounds:

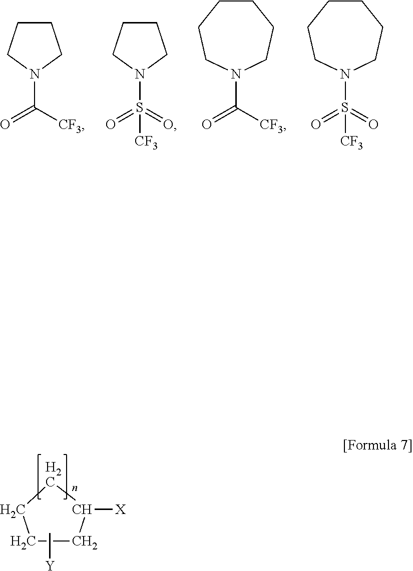

As an example of the present disclosure, the compound represented by Formula 7 may function as an anion receptor in an electrolyte composition (or electrolyte), and in Formula 7, Y, R₁ and n are the same as defined in Formula 1.

As an example of the present disclosure, the compound represented by Formula 7 may be selected from the following compounds:

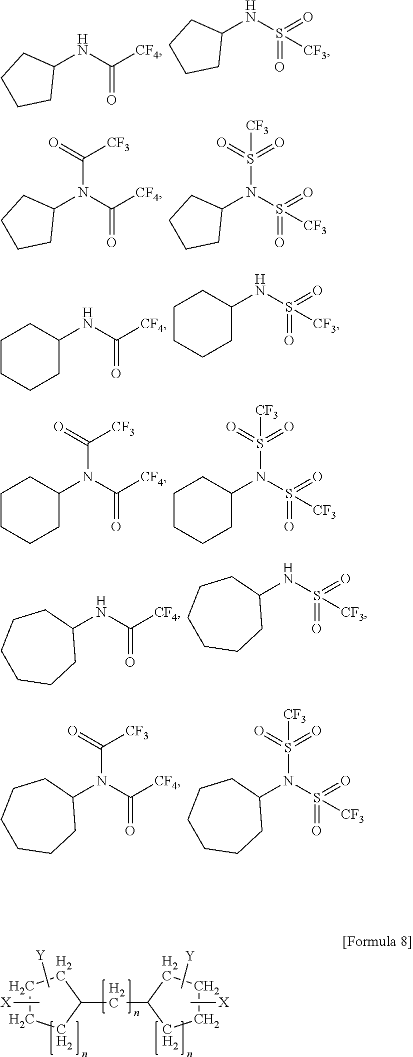

As an example of the present disclosure, the compound represented by Formula 8 may function as an anion receptor in an electrolyte composition (or electrolyte), and in Formula 8, Y, R₁ and n are the same as defined in Formula 1.

As an example of the present disclosure, the compound represented by Formula 8 may be selected from the following compounds:

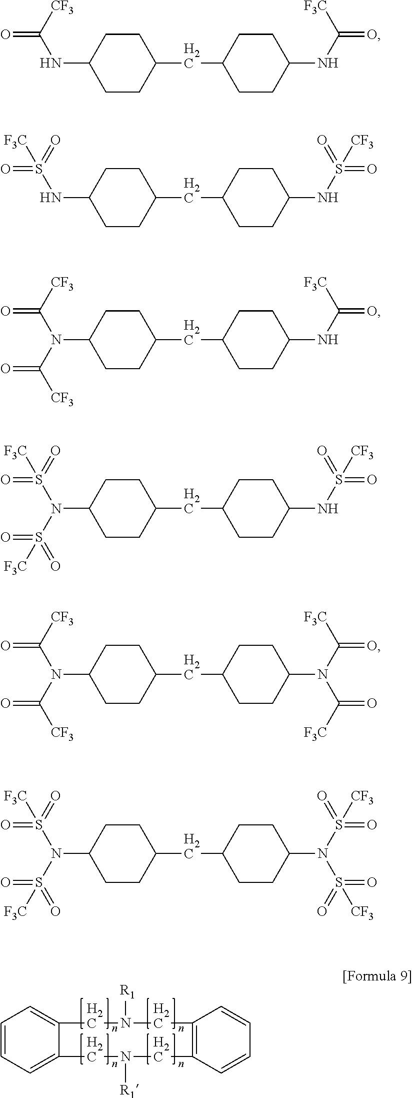

As an example of the present disclosure, the compound represented by Formula 9 may function as an anion receptor in an electrolyte composition (or electrolyte), and in Formula 9, Y and n are the same as defined in Formula 1 and R₁ and R₁′ are the same as defined in Formula 4.

As an example of the present disclosure, the compound represented by Formula 9 may be selected from the following compounds:

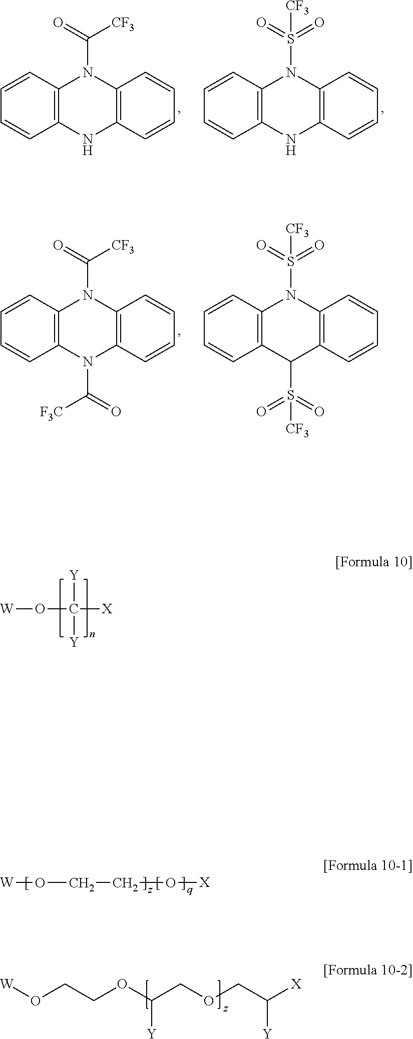

As an example of the present disclosure, each of the compounds represented by Formula 10, Formula 10-1, and Formula 10-2 can function as an anion receptor in an electrolyte, X, Y, and n are the same as defined in Formula 1, W is selected from a hydrogen atom, a halogen atom, a linear or branched alkyl group having 1 to 20 carbon atoms, a linear or branched alkenyl group having 2 to 20 carbon atoms, a linear or branched alkynyl group having 2 to 20 carbon atoms,

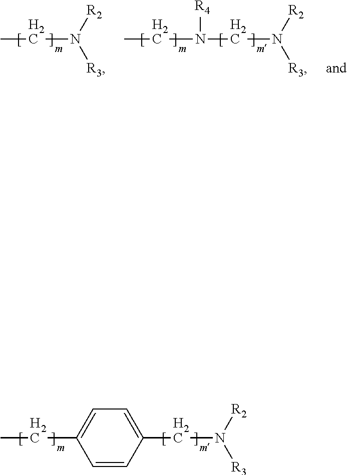

(R₂, R₃, and R₄ are each selected from a hydrogen atom, a halogen atom, and an electron withdrawing functional group that is selected from —SO₂CF₃, —COCF₃, —SO₂CN, —CF₃, and —CN; there is not case where R₂, R₃, and R₄ are all a hydrogen atom at the same time; and m and m′ are each independently an integer in a range of from 0 to 20), in which z is an integer in a range of from 1 to 20, and n and q are each an integer in a range of from 0 to 20. Preferably, z is an integer in a range of from 0 to 10, and n and q are each an integer in a range of from 0 to 10.

As an example of the present disclosure, each of the compounds represented by Formulas 10, 10-1, and 10-2 may be selected from the following compounds:

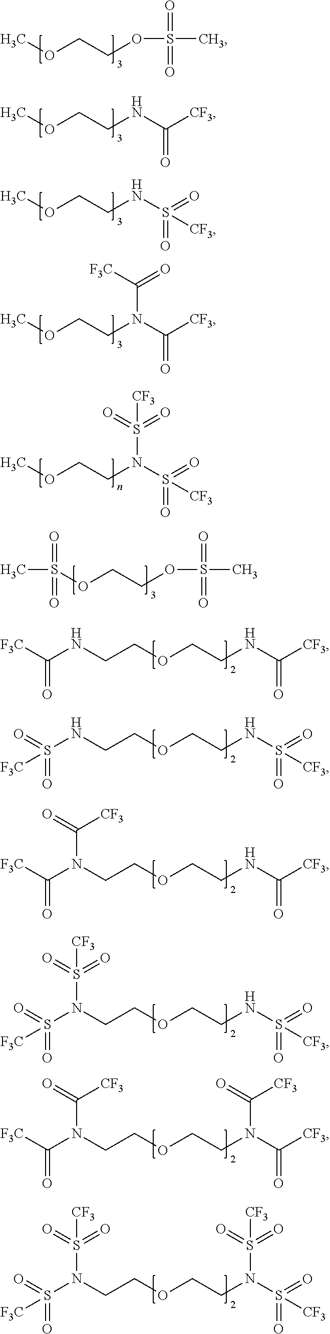

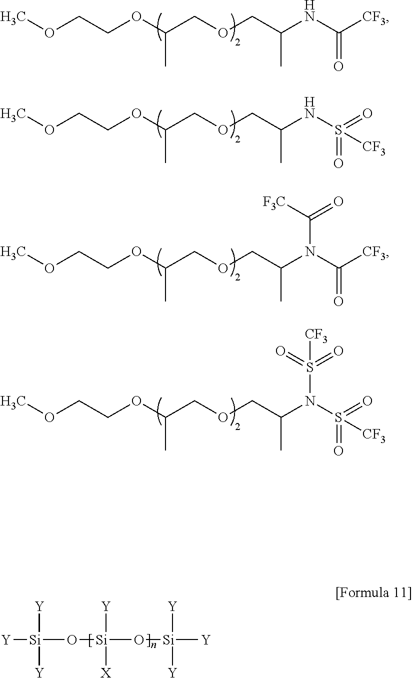

As an example of the present disclosure, the compound represented by Formula 11 may function as an anion receptor in an electrolyte composition (or electrolyte), and in Formula 11, X, Y, and n are the same as defined in Formula 1.

As an example of the present disclosure, the compound represented by Formula 11 may be selected from the following compounds:

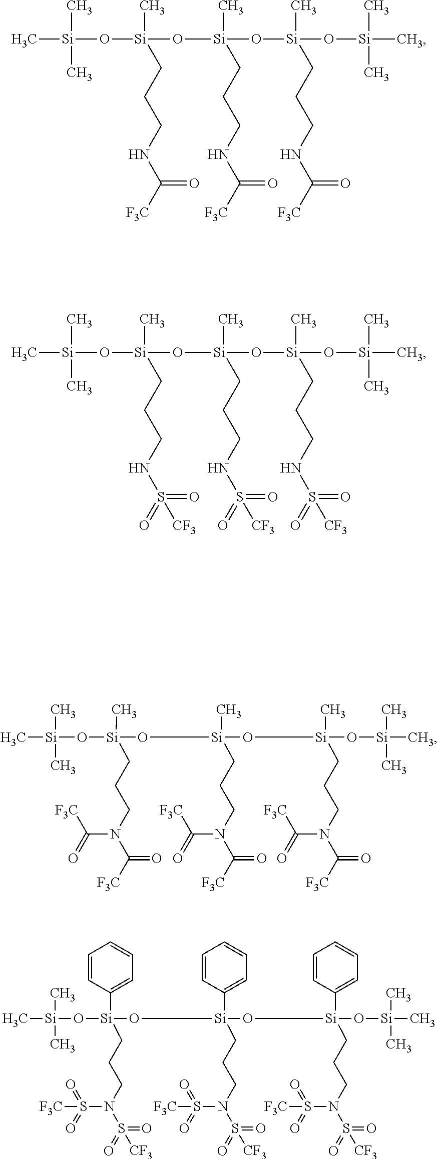

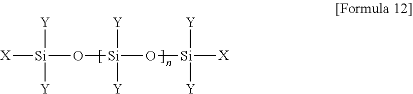

As an example of the present disclosure, the compound represented by Formula 12 may function as an anion receptor in an electrolyte composition (or electrolyte), and in Formula 12, X, Y, and n are the same as defined in Formula 1.

As an example of the present disclosure, the compound represented by Formula 12 may be selected from the following compounds:

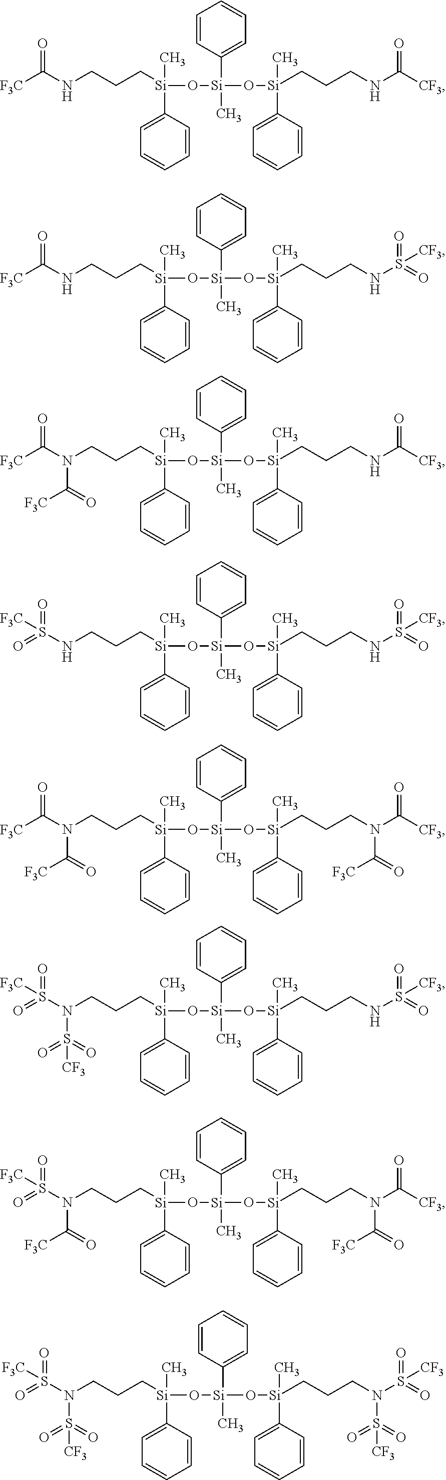

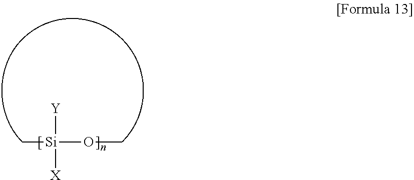

As an example of the present disclosure, the compound represented by Formula 12 may function as an anion receptor in an electrolyte composition (or electrolyte), and in Formula 13, X, Y, and n are the same as defined in Formula 1.

As an example of the present disclosure, the compound represented by Formula 13 may be selected from the following compounds:

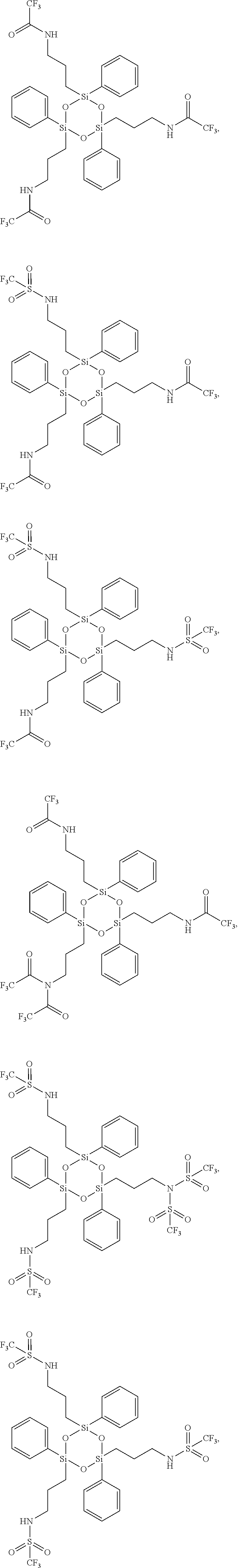

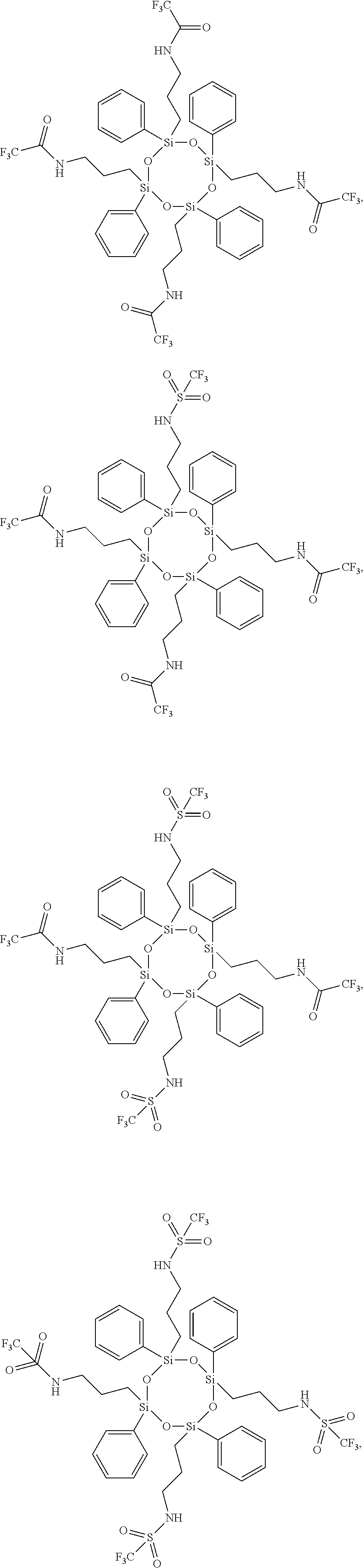

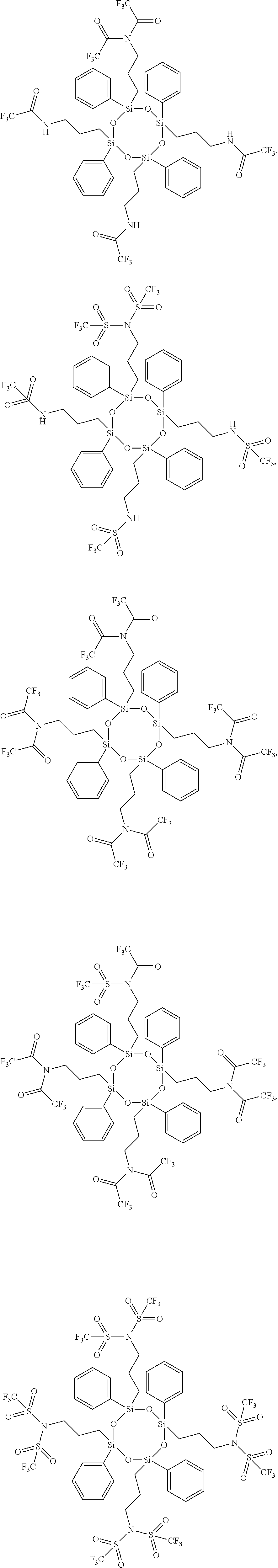

According to one embodiment of the present disclosure, the anion receptor is contained in an amount of 0.01% to 40% by weight, 0.01% to 35% by weight, 0.01% to 30% by weight, 0.01% to 20% by weight, 0.01% to 10% by weight, 0.1% to 10% by weight, 0.5% to 5% by weight, 1% to 2% by weight, with respect to the total weight of the electrolyte composition. When the content of the anion receptor is less than 0.01% by weight, the effect of the anion receptor cannot be sufficiently exhibited. When the content exceeds 40% by weight, it is difficult to obtain the effect of improving ionic conductivity, electrochemical stability, and low-temperature performance.

According to one embodiment of the present disclosure, at least one of the compounds represented by Formulas 4 to 13 is present, with respect to the total weight of the anion receptors, in an amount of 0.01% to 50% by weight (or less than 50% by weight), 0.1% to 50% by weight, 1% to 50% by weight, 2% to 40% by weight, or 10% to 30% by weight When the content of the anion receptors satisfies any one of the ranges, an electrolyte with improved ionic conductivity and electrochemical stability at room temperature can be obtained.

According to an embodiment of the present disclosure, among the anion receptors, the mixing ratio (w/w) of at least one of the silicon compounds represented by Formulas 4 to 13 to at least one compound represented by Formulas 1 to 3 is in a range of 99:1 to 50:50. When the mixing ratio falls within the range, the effect of improving ionic conductivity and electrochemical stability at room temperature can be obtained.

According to one embodiment of the present disclosure, the electrolyte composition includes an alkali metal ion-containing material and a non-aqueous solvent As an example of the present disclosure, any non-aqueous solvent can be used without limitation as long as it is a non-aqueous solvent applicable to batteries. For example, the non-aqueous solvent may include at least one selected from the group consisting of ethylene carbonate (EC), dimethyl carbonate (DMC), diethyl carbonate (DEC), and propylene. carbonate (PC), dipropyl carbonate, ethylmethyl carbonate (EMC), methylpropyl carbonate and ethylpropyl carbonate, 1,2-butylene carbonate, 2,3-butylene carbonate, 1,2-pentylene carbonate, 2,3-pentylene carbonate, vinylene carbonate, ether, organic carbonate, lactone, formate, ester, sulfonate, nitrite, oxazolidinone, tetrahydrofuran, 2-methyltetrahydrofuran, 4-methyl-1,3 -dioxolane, 1,3-dioxolane, 1,2-dimethoxyethane, dimethoxymethane, γ-butyrolactone, methyl formate, sulfolane, acetonitrile, 3-methyl-2-oxazolidinone, and N-methyl-2-pyrrolidinone, but is not limited thereto.

As an example of the present disclosure, the content of the non-aqueous solvent in the electrolyte composition may be 1% by weight or more, 15% by weight or more, 30% by weight or more, or 60% by weight or more, or may be in a range of 80% to 99% by weight, based on the total weight of the electrolyte composition or the balance.

As an example of the present disclosure, the alkali metal ion-containing material is an alkali metal ion-containing electrolyte salt For example, it is a lithium salt containing Li⁺ as a cation. As an example of the present disclosure, as the lithium salt, any lithium salt that is applicable to the electrolyte of a battery can be used without limitation. For example, the lithium salt may include at least one selected from the group consisting of LiSO₃CF₃, LiCOOC₂F₅, LiN(SO₂CF₃)₂, LiC(SO₂CF₃)₃, LiClO₄, LiAsF₆, LiBF₄, LiPF₆, LiSbF₆, LiI, LiBr, and LiCl but is not limited thereto.

According to one embodiment of the present disclosure, the content of the alkali metal ion-containing material in the electrolyte composition is in a range of 3% to 60% by weight, 3% to 50% by weight, 10% to 50% by weight, 20% to 50% by weight, 3% to 10% by weight, or 3% to 5% by weight, with respect to the total weight of the 0.5% to 5% by weight, 1% to 2% by weight, with respect to the total weight of the electrolyte composition. With the addition of an appropriate amount of alkali ion, the battery can exhibit and maintain stable performance.

According to one embodiment of the present disclosure, the electrolyte composition may form a non-aqueous liquid electrolyte, a gel-type polymer electrolyte, and/or a solid polymer electrolyte, and the electrolyte composition may optionally further include additional components depending on the type of an electrolyte to be prepared from the electrolyte composition. For example, polymeric compounds, polymer supports, additives (for example, a curing initiator, a polymerization inhibitor, etc.) may be added.

According to one embodiment of the present disclosure, the electrolyte composition may form a non-aqueous liquid electrolyte. For example, the electrolyte composition to be used to form a non-aqueous liquid electrolyte may include the following:

(i) an anion receptor including one or more of the silicon compounds that are represented by Formulas 1 to 3 and in which an amine group containing an electron withdrawing functional group as a substituent is introduced into a silicon atom, or an electron withdrawing functional group is introduced into a nitrogen atom in a ring;

or an anion receptor that is a mixture of one or more of the novel silicon compounds represented by Formulas 1 to 3 and at least one compound selected from among linear hydrocarbon compounds represented by Formula 4, cyclic hydrocarbon compounds represented by Formulas 5 to 9, polyalkylene oxide compounds represented by Formula 10, and siloxane compounds represented by Formulas 11 to 13, wherein in each of the compounds, an amine group containing an electron withdrawing functional group as a substituent is introduced, or an electron withdrawing functional group is introduced in a nitrogen atom in a ring;

(ii) a non-aqueous solvent; and

(iii) an alkali metal ion-containing material.

As an example of the present disclosure, in the electrolyte composition for a non-aqueous liquid electrolyte, (i) the anion receptor, (ii) the non-aqueous solvent, and (iii) the alkali metal ion-containing material are the same as mentioned in the description of the electrolyte composition. Preferably, in the electrolyte composition for a non-aqueous liquid electrolyte, based on the total weight of the electrolyte composition, the content of the anion receptor is in a range of 0.01% to 5% by weight, and the content of the non-aqueous solvent is 80% by weight or more or in a range of 95% to 99% by weight, and the content of the alkali metal ion-containing material is in a range of 10% to 30% by weight, 12% to 20% by weight, or 12% to 15% by weight.

According to one embodiment of the present disclosure, the electrolyte composition may form a gel-type polymer electrolyte. For example, the electrolyte composition for a gel-type polymer electrolyte may include the following:

(i) an anion receptor including one or more of the novel silicon compounds that are represented by Formulas 1 to 3 and in which an amine group containing an electron withdrawing functional group as a substituent is introduced into a silicon atom, or an electron withdrawing functional group is introduced into a nitrogen atom in a ring;

or an anion receptor that is a mixture of one or more of the novel silicon compounds represented by Formulas 1 to 3 and at least one compound selected from among linear hydrocarbon compounds represented by Formula 4, cyclic hydrocarbon compounds represented by Formulas 5 to 9, polyalkylene oxide compounds represented by Formula 10, and siloxane compounds represented by Formulas 11 to 13, wherein in each of the compounds, an amine group containing an electron withdrawing functional group as a substituent is introduced, or an electron withdrawing functional group is introduced in a nitrogen atom in a ring;

(ii) a polymeric compound selected from linear, reticulate, comb-shaped, or branched polymeric compounds, a crosslinkable polymeric compound, or both;

(iii) a polymer support

(iv) a non-aqueous solvent; and

(v) an alkali metal ion-containing material.

As an example of the present disclosure, in the electrolyte composition for a gel-type polymer electrolyte, (i) the anion receptor, (iv) the non-aqueous solvent, and (v) the alkali metal ion-containing material are the same as mentioned in the description of the electrolyte composition. Preferably, in the electrolyte composition for a gel-type polymer electrolyte, based on the total weight of the electrolyte composition, the content of (i) the anion receptor is in a range of 0.01% to 30% by weight, the content of (iv) the non-aqueous solvent is in a range of 20% to 80% by weight, and the content of (v) the alkali metal ion-containing material may be in a range of 10% to 30% by weight.

As an example of the present disclosure, in the electrolyte composition for a gel-type polymer electrolyte, any polymeric compound selected from (ii) the linear, reticulate, comb-shaped, or branched polymeric compounds can be used without limitation as long as it is applicable to batteries (i.e., electrolytes). For example, a flexible inorganic polymer, a linear polyether, or both may be included.

As an example of the present disclosure, the flexible inorganic polymer may be selected from polysiloxane, polyphosphazene, or copolymers thereof, and the linear polyether may be polyalkylene oxide.

As an example of the present disclosure, as the crosslinkable polymeric compound, any compound can be used without limitation as long as it is applicable to batteries (i.e., electrolytes). For example, the crosslinkable polymeric compound includes one or more selected from flexible inorganic polymers, or polymeric compounds having a linear polyether backbone and a functional group such as acrylic, epoxy, trimethylsilyl, silanol, vinylmethyl, or divinylmonomethyl at the end thereof, but examples of the crosslinkable polymeric compound are not limited thereto. For example, the crosslinkable polymeric compound may be bisphenol A ethoxylate dimethacrylate (Bis-15m) represented by Formula 14 below or polyethylene glycol dimethacrylate (PEGDMA) represented by Formula 15 below but is not limited thereto.

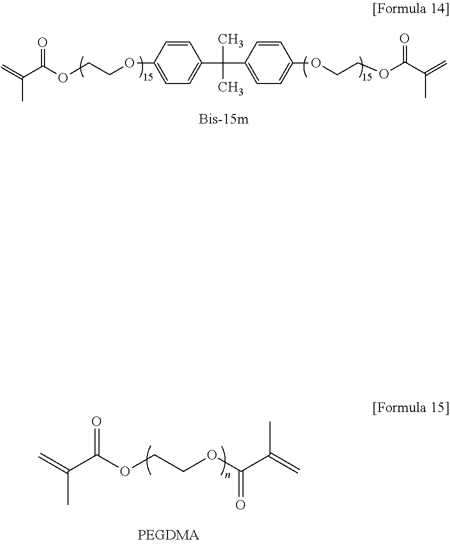

As an example of the present disclosure, the content of (ii) the polymeric compound selected from linear, network, comb-shaped, or branched polymeric compounds, the crosslinkable polymeric compound, or both in the electrolyte composition is in a range of 0.01% to 30% by weight with respect to the total weight of the electrolyte composition. When the range is satisfied, the electrolyte composition has improved mechanical properties and processability. When the content exceeds 80% by weight, the electrolyte composition may have poor processability due to low viscosity, and on the other hand, when the content is less than 20% by weight, the electrolyte composition may have poor mechanical properties.

As an example of the present disclosure, as (ii) the polymer support, any polymer support can be used without limitations as long as it is a polymer support applicable to batteries (i.e., electrolytes). For example, at least one selected from the group consisting of polyalkylene glycol polymers, polysiloxane polymers, acrylonitrile (PAN)-based polymers, and polyvinylidene fluoride (PVDF)-hexafluoropropylene-based polymers may be used, but examples of the polymer support are not limited thereto.

As one example of the present disclosure, in the electrolyte composition for a gel-type polymer electrolyte, the content of the polymer support is in a range of 1% to 40% by weight or 5% to 40% by weight, based on the total weight of the electrolyte composition. When the content of the polymer support is within the range mentioned above, leakage problems that may occur in gel-type polymer electrolytes can be solved, and an electrolyte with improved stability and electrical performance can be provided.

According to one embodiment of the present disclosure, the electrolyte composition for a gel-type polymer electrolyte may further include a curing initiator in the case of containing the crosslinkable polymeric compound. As an example of the present disclosure, the curing initiator may include a photocuring initiator, a thermosetting initiator, or both. For example, the photocuring initiator may include at least one selected from the group consisting of dimethylphenyl acetophenone (DMPA), t-butyl peroxypivalate, ethyl benzoin ether, isopropyl benzoin ether, α-methyl benzoin ethyl ether, benzoin phenyl ether, α-acyloxime ester, α,α-diethoxyacetophenone, 1,1-dichloroacetophenone, 2-hydroxy-2-methyl-1-phenylpropan-1-one, 1-hydroxycyclohexyl phenyl ketone, anthraquinone, thioxanthone, isopropylthioxanthone, chlorothioxanthone, benzophenone, p-chlorobenzophenone, benzyl benzoate, benzoyl benzoate, and Michler's ketone, but is not limited thereto. For example, the thermosetting initiator may include an azoisobutyronitrile-based compound, a peroxide based compound, or both. More specifically, the thermal setting initiator includes at least one selected from the group consisting of 2,2′-azobis(2-methylbutyronitrile), 2,2′-azobis(isobutyronitrile), 2,2′-azobis(2,4-dimethylvaleronitrile), 2,2′-azobis(4-methoxy-2,4- dimethylvaleronitrile), tetramethylbutylperoxy neodecanoate, bis(4-butylcyclohexypperoxydicarbonate, di(2-ethylhexyl)peroxy carbonate, butylperoxy neodecanoate, and dipropyl peroxyl dicarbonate, etc., but is not limited thereto.

As one example of the present disclosure, in the electrolyte composition for a gel-type polymer electrolyte, the content of the curing initiator is in a range of 1×10⁻⁴% to 0.1% by weight, based on the total weight of the electrolyte composition. When the content of the curing initiator is within the mentioned range, an electrolyte with improved stability and electrical performance can be provided.

According to one embodiment of the present disclosure, the electrolyte composition for a gel-type polymer electrolyte may further include a polymerization inhibitor along with the curing initiator to prevent crosslinking of a specific polymeric compound at or below an appropriate temperature or in the case where a polymeric compound that must not be crosslinked at or below the appropriate temperature is included. That is, by adding the polymerization inhibitor, a solidifying electrolyte having a solidifying agent function can be provided.

As an example of the present disclosure, as the polymerization inhibitor, any material that is applicable to batteries (i.e., electrolytes) and that has a polymerization prevention or inhibition function can be used. For example, the polymerization inhibitor includes at least one selected from the group consisting of p-benzoquinone, 4-methoxyphenol, 4-t-butylcatechol, phenothiazine, hydroquinone, naphthoquinone, phenanthroquinone, toluquinone, 2,5-diacetoxy-p-benzoquinone, 2,5-dicaproxy-p-benzoquinone, 2,5-acyloxy-p-benzoquinone, 2,5-di-t-butylhydroquinone, p-tert-butylcatechol, mono-t-butylhydroquinone, 2,5-di-t-amylhydroquinone, 2,5-di-t-amylhydroquinone, etc., but is not limited thereto.

As an example of the present disclosure, in the gel-type electrolyte, the content of the polymerization inhibitor is in a range of 0.01% to 3% by weight, based on the total weight of the electrolyte. When contained within the range mentioned above, it is possible to inhibit crosslinking of a specific polymeric compound, to prevent hardening during storage and transportation of the product, and to provide an electrolyte that can prevent deterioration of electrolyte function and battery performance due to high temperature or thermal runaway caused by crosslinking at a specific temperature.

According to one embodiment of the present disclosure, the electrolyte composition may form a solid polymer electrode. For example, the electrolyte composition for a solid polymer electrolyte may include the following:

(i) an anion receptor including one or more of the silicon compounds that are represented by Formulas 1 to 3 and in which an amine group containing an electron withdrawing functional group as a substituent is introduced into a silicon atom, or an electron withdrawing functional group is introduced into a nitrogen atom in a ring;

or an anion receptor including at least one of silicon compounds represented by Formulas 1 to 3 and compounds selected from among linear hydrocarbon compounds represented by Formula 4, cyclic hydrocarbon compounds represented by Formulas 5 to 9, polyalkylene oxide compounds represented by Formula 10, and siloxane compounds represented by Formulas 11 to 13, wherein in each of the compounds, an amine group containing an electron withdrawing functional group as a substituent is introduced, or an electron withdrawing functional group is introduced in a nitrogen atom in a ring;

(ii) a polymeric compound selected from linear, reticulate, comb-shaped, or branched polymeric compounds, or a crosslinkable polymeric compound;

(iii) a polymer support;

(iv) a non-aqueous solvent; and

(v) an alkali metal ion-containing material.

In addition, the electrolyte composition for a solid polymer electrolyte may further include a single compound or a combination of two or more compounds selected from (vi) polyalkylene glycol dialkyl ether and the non-aqueous solvent.

As an example of the present disclosure, in the electrolyte composition for a solid polymer electrolyte, (i) the anion receptor, (iv) the non-aqueous solvent, and (v) the alkali metal ion-containing material are the same as mentioned in the description of the electrolyte composition. Preferably, in the electrolyte composition for a solid polymer electrolyte, the content of (i) the anion receptor is in a range of 0.01% to 30% by weight, the content of (iv) the non-aqueous solvent is in a range of 0% to 10% by weight, and the content of (v) the alkali metal ion-containing material may be in a range of 10% to 70% by weight.

As an example of the present disclosure, in the electrolyte composition for a solid polymer electrolyte, any polymeric compound selected from (ii) the linear, reticulate, comb-shaped, or branched polymeric compounds can be used without limitation as long as it is applicable to batteries (i.e., electrolytes). For example, a flexible inorganic polymer, a linear polyether, or both may be included.

As an example of the present disclosure, the flexible inorganic polymer may be selected polysiloxane, polyphosphazene, or a copolymer thereof and the linear polyether may be polyalkylene oxide.

As an example of the present disclosure, as the crosslinkable polymeric compound, any compound can be used without limitation as long as it is applicable to batteries (i.e., electrolytes). For example, the crosslinkable polymeric compound includes one or more selected from flexible inorganic polymers, or polymeric compounds having a linear polyether backbone and a functional group such as acrylic, epoxy, trimethylsilyl, silanol, vinylmethyl, or divinylmonomethyl at the end thereof, but examples of the crosslinkable polymeric compound are not limited thereto. For example, the crosslinkable polymeric compound may be bisphenol A ethoxylate dimethacrylate (Bis-15m) represented by Formula 14 below or polyethylene glycol dimethacrylate (PEGDMA) represented by Formula 15 below but is not limited thereto.

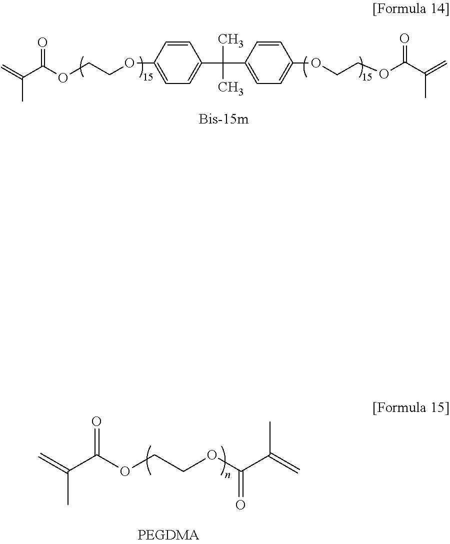

As an example of the present disclosure, the content of (ii) the polymeric compound selected from linear, network, comb-shaped, or branched polymeric compounds, the crosslinkable polymeric compound, or both is in a range of 20% to 90% by weight, based on the total weight of the electrolyte composition for a solid polymer electrolyte. When the above mentioned range is satisfied, mechanical properties can be improved, and stable performance of batteries can be provided.

As an example of the present disclosure, as (ii) the polymer support, any polymer support can be used without limitation as long as it is a polymer support applicable to batteries (i.e., electrolytes). For example, at least one selected from the group consisting of polyalkylene glycol polymers, polysiloxane polymers, acrylonitrile (PAN)-based polymers, and polyvinylidene fluoride (PVDF)-hexafluoropropylene-based polymers may be used, but examples of the polymer support are not limited thereto.

As one example of the present disclosure, in the electrolyte composition for a solid polymer electrolyte, the content of the polymer support is in a range of 1% to 30% by weight, based on the total weight of the electrolyte composition. When the above-mentioned range is satisfied, an electrolyte with improved stability and electrical performance can be provided.

According to one embodiment of the present disclosure, the electrolyte composition for a solid polymer electrolyte may further include a curing initiator in the case that the crosslinkable polymeric compound is included in the electrolyte composition. As an example of the present disclosure, the curing initiator may include a photocuring initiator, a thermosetting initiator, or both. For example, the photocuring initiator may include at least one selected from the group consisting of dimethylphenyl acetophenone (OMPA), t-butyl peroxypivalate, ethyl benzoin ether, isopropyl benzoin ether, α-methyl benzoin ethyl ether, benzoin phenyl ether, α-acyloxime ester, α,α-diethoxyacetophenone, 1,1-dichloroacetophenone, 2-hydroxy-2-methyl-1-phenylpropan-1-one, 1-hydroxycyclohexyl phenyl ketone, anthraquinone, thioxanthone, isopropylthioxanthone, chlorothioxanthone, benzophenone, p-chlorobenzophenone, benzyl benzoate, benzoyl benzoate, and Michler's ketone, but is not limited thereto. For example, the thermosetting initiator may include an azoisobutyronitrile-based compound, a peroxide-based compound, or both. More specifically, the thermal setting initiator may be 2,2′-azobis(2-methylbutyronitrile), 2,2′-azobis(isobutyronitrile), 2,2′-azobis(2,4-dimethylvaleronitrile), 2,2′-azobis(4-methoxy-2,4-dimethylvaleronitrile), tetramethylbutylperoxy neodecanoate, bis(4-butylcyclohexyl)peroxydicarbonate, di(2-ethylhexyl)peroxy carbonate, butylperoxy neodecanoate, or dipropyl peroxyl dicarbonate, but it is not limited thereto.

As one example of the present disclosure, in the electrolyte composition for a solid polymer electrolyte, the content of the curing initiator is in a range of 1×10⁻⁴% to 0.1% by weight, based on the total weight of the electrolyte composition. When the above-mentioned range is satisfied, the polymer support can provide an electrolyte with improved stability and electrical performance.

According to one embodiment of the present disclosure, the electrolyte composition for a solid polymer electrolyte may further include a polymerization inhibitor along with the curing initiator to prevent crosslinking of a specific polymeric compound at or below an appropriate temperature or in the case where a polymeric compound that must not be crosslinked is included. That is, a solidifying electrolyte can be produced by adding the polymerization inhibitor.

As an example of the present disclosure, as the polymerization inhibitor, any polymer support that is applicable to batteries (i.e., electrolytes) and that has a polymerization prevention or inhibition function can be used without limitations. For example, the polymerization inhibitor may include at least one selected from the group consisting of p-benzoquinone, 4-methoxyphenol, 4-t-butylcatechol, phenothiazine, hydroquinone, naphthoquinone, phenanthroquinone, toluquinone, 2,5-diacetoxy-p-benzoquinone, 2,5-dicaproxy-p-benzoquinone, 2,5-acyloxy-p-benzoquinone, 2,5-di-t-butylhydroquinone, p-tert-butylcatechol, mono-t-butylhydroquinone, and 2,5-di-t-amylhydroquinone, 2,5-di-t-amylhydroquinone, but is not limited thereto.

As an example of the present disclosure, in the solid polymer electrolyte, the content of the polymerization inhibitor is in a range of 0.01% to 3% by weight, based on the total weight of the electrolyte. When the polymerization inhibitor is contained in an amount that falls within the range mentioned above, it is possible to inhibit crosslinking of a specific polymeric compound, to prevent hardening during storage and transportation of the product, and to provide an electrolyte that can prevent deterioration of electrolyte function and battery performance attributed to high temperature or thermal runaway caused by crosslinking at a specific temperature.

According to one embodiment of the present disclosure, the polyalkylene glycol dialkyl ether or non-aqueous solvent that may be included in the solid polymer electrolyte serves as a plasticizer in conjunction with the anion receptor of the present disclosure. Examples of the polyalkylene glycol dialkyl ether include at least one selected from the group consisting of polyethylene glycol dimethyl ether (PEGDME), polyethylene glycol diethyl ether, polyethylene glycol dipropyl ether, polyethylene glycol dibutyl ether, polyethylene glycol diglycidyl ether, polypropylene glycol dimethyl ether, polypropylene glycol diglycidyl ether, dibutyl ether-terminated polypropylene glycol/polyethylene glycol copolymer, and dibutyl ether-terminated polyethylene glycol/polypropylene glycol/polyethylene glycol block copolymer but are not limited thereto.

As an example of the present disclosure, the polyalkylene glycol dialkyl ether or non-aqueous solvent may be contained in an amount of 1% to 30% by weight with respect to the total weight of the electrolyte composition for a solid polymer electrolyte.

According to one embodiment of the present disclosure, the electrolyte composition may form a solidifying electrolyte. For example, the electrolyte composition for a solidifying electrolyte may include:

(i) an anion receptor including silicon compounds that are represented by Formulas 1 to 3 and in which an amine group containing an electron withdrawing functional group as a substituent is introduced into a silicon atom, or an electron withdrawing functional group is introduced into a nitrogen atom in a ring;

or an anion receptor including at least one of silicon compounds represented by Formulas 1 to 3 and compounds selected from among linear hydrocarbon compounds represented by Formula 4, cyclic hydrocarbon compounds represented by Formulas 5 to 9, polyalkylene oxide compounds represented by Formula 10, and siloxane compounds represented by Formulas 11 to 13, wherein in each of the compounds, an amine group containing an electron withdrawing functional group as a substituent is introduced, or an electron withdrawing functional group is introduced in a nitrogen atom in a ring;

(ii) a polymeric compound selected from linear, reticulate, comb-shaped, or branched polymeric compounds, or a crosslinkable polymeric compound;

(iii) a polymer support;

(iv) a non-aqueous solvent;

(v) an alkali metal ion-containing material; and

(vi) a polymerization inhibitor.

Optionally, the electrolyte composition for a solidifying polymer electrolyte may further include a single compound or a combination of two or more compounds selected from (vi) polyalkylene glycol dialkyl ether and the non-aqueous solvent

As an example of the present disclosure, the above-mentioned components (i) to (vii) are the same as those mentioned in the description of the electrolyte composition for a gel-type polymer electrolyte or the electrolyte composition for a solid polymer electrolyte. Preferably, the total content of the polymeric compound, the crosslinkable polymeric compound, and the anion receptor is 12% by weight or more, or 13% by weight or more, based on the weight of the electrolyte composition for a solidifying electrolyte. When these components are contained in an amount that is equal to or higher than the lower limit of the mentioned range, a solidification function that enables a rapid curing reaction at a temperature at which a fire may occur in an electrolyte or battery, for example, about 130° C. or higher can be provided. In addition, the content of (iv) the non-aqueous solvent may be in a range of 20% to 80% by weight, based on the total weight of the electrolyte composition for a solidifying electrolyte.

The present disclosure relates to an electrolyte containing the novel anion receptor of the present disclosure.

According to one embodiment of the present disclosure, an electrolyte is prepared from the electrolyte composition of the present disclosure, and for example, the electrolyte may be a liquid, gel-type or solid electrolyte. For example, the electrolyte may be a non-aqueous liquid electrolyte, a gel-type polymer electrolyte, a solid polymer electrolyte, a polymer electrolyte membrane, and/or a solidifying electrolyte.

According to one embodiment of the present disclosure, the solidifying electrolyte may be manufactured from the electrolyte composition for a gel-type polymer electrolyte and/or the electrolyte composition for a solid polymer electrolyte, and may be prepared from the electrolyte composition that does not cause a curing reaction. In addition, the electrolyte has a viscosity close to that of a liquid and/or fluidity. When the electrolyte is applied to a battery, at or above a certain temperature, for example, 120° C., or at a high temperature of 130° C. or higher, a curing reaction progresses quickly and rapidly, thereby stopping the operation of the battery employing the electrolyte, and preventing risks such as fire by ensuring the stability of the battery at high temperatures and preventing thermal runaway in the battery.

According to one embodiment of the present disclosure, the polymer electrolyte membrane may be prepared by a curing process using the electrolyte composition for a gel-type polymer electrolyte and/or the electrolyte composition for a solid polymer electrolyte.

According to an embodiment of the present disclosure, the polymer electrolyte membrane can be manufactured by a method described below. As an example of the present disclosure, the manufacturing method includes the steps of preparing an electrolyte composition by mixing constituent components; applying the electrolyte composition on a substrate; and drying and curing the electrolyte composition to produce a thin film.

As an example of the present disclosure, when forming a gel-type polymer electrolyte membrane,

in the step of preparing the electrolyte composition, an electrolyte composition for a gel-type polymer electrolyte can be prepared. To this end, a non-aqueous solvent, an anion receptor, and an alkali metal ion-containing material are placed in a container at an appropriate mixing ratio, the mixture is stirred with a stirrer to prepare a solution, and then the polymer described above is added, and then mixed together. In this case, when mixing the polymer support, if necessary, the polymer support can be melted by applying a predetermined amount of heat to prepare a mixed solution of the gel-type polymer electrolyte composition for producing a gel-type polymer electrolyte membrane of the present disclosure.

For example, in the step of forming the membrane, the mixture of the prepared composition is applied to an appropriate thickness on a support substrate made of glass or polyethylene, or a commercial Mylar film. Next, the coated substrate is dried, exposed to electron beams, ultraviolet rays, or gamma rays, or heated to cause a curing reaction, resulting in the formation of a membrane (thin film). As another example, the step of forming the membrane involves applying the composition mixture on the support substrate, fixing both ends of the support substrate with thickness-adjusting spacers, covering the support substrate with another support substrate, and causing a curing reaction using a curing light source or a heat source, resulting the formation of a gel-type polymer electrolyte membrane.

As an example of the present disclosure, when forming a solid polymer electrolyte membrane,

for example, in the step of preparing the electrolyte composition, an electrolyte composition for a solid polymer electrolyte is prepared. To this end, a non-aqueous solvent, an anion receptor, or polyalkylene glycol dialkyl ether, and an alkali metal ion-containing material are placed in a container at an appropriate mixing ratio, the mixture is stirred with a stirrer to prepare a solution, and then a reticulate, branched, or comb-shaped polymeric compound or a crosslinkable polymeric compound is added thereto and mixed. Next, when adding and mixing the reticulate, branched, or comb-shaped polymeric compound a certain amount of heat can be applied if necessary. When a crosslinkable polymeric compound is added and mixed with the mixture, a curing initiator and a polymerization inhibitor may be added and stirred to prepare a mixed solution of the solid polymer electrolyte composition for producing the solid polymer electrolyte membrane of the present disclosure.

For example, in the step of forming the membrane, the mixture of the prepared composition is applied to an appropriate thickness on a support substrate made of glass or polyethylene, or a commercial Mylar film. Next, the coated substrate is dried, exposed to electron beams, ultraviolet rays, or gamma rays, or heated to cause a curing reaction, resulting in the formation of a membrane (thin film). As another example, the step of forming the membrane involves applying the composition mixture on a support substrate, fixing both ends of the support substrate with thickness-adjusting spacers, covering the support substrate with another support substrate, and causing a curing reaction using a curing light source or a heat source, resulting the formation of a solid polymer electrolyte membrane.

The present disclosure relates to a part or component of an electrochemical battery including the novel anion receptor of the present disclosure.

According to one embodiment of the present disclosure, the part or component may be an anode coated or impregnated with the anion receptor, a cathode coated or impregnated with the anion receptor, a current collector and/or separator of the anode or cathode, an electrolyte containing the anion receptor, a battery membrane, or the like.

For example, the anion receptor can be applied to an electrolyte composition, a process composition, etc.

For example, for the anode and cathode, the anion receptor may be added when preparing an active material slurry therefor.

For example, the part or component may be a separator impregnated or coated with the anion receptor.

For example, the part or component may be a battery membrane (for example, polymer electrolyte membrane), film, and/or sheet each of which contains the anion receptor compound or prepared from the electrolyte composition (for example, curing, molding, etc.).

For example, the electrolyte may be a liquid, gel-type, or solid electrolyte prepared using the electrolyte composition of the present disclosure. The gel-type and solid electrolytes may be a gel-type polymer electrolyte membrane and a solid polymer electrolyte membrane, respectively.

The present disclosure relates to an electrochemical battery including the novel anion receptor of the present disclosure.

According to one embodiment of the present disclosure, the electrochemical battery may be a primary or secondary battery and may include a liquid, gel-type, and/or solid electrolyte (for example, a gel-type polymer electrolyte and a solid polymer electrolyte) prepared from the electrolyte composition of the present disclosure.

According to one embodiment of the present disclosure, a battery using the liquid or gel-type polymer electrolyte of the present disclosure may include an anode, a cathode, and a separator, and a battery using the solid polymer electrolyte of the present disclosure may include an anode and a cathode. In addition to the above-mentioned battery configuration, configurations known in the technical field of the present disclosure may be further included for driving or operating the battery, but are not specifically mentioned in this document.

According to an embodiment of the present disclosure, the anode and cathode may be an anode and cathode that can be used in the battery known in the art to which the present disclosure pertains or an anode and cathode that are manufactured by a manufacturing method known in the art to which the present disclosure pertains, and the battery can be assembled by a conventional method of assembling an anode, a cathode, and an electrolyte.

As an example of the present disclosure, the anode may include: lithium; a lithium alloy such as Li—Al, Li—Si, and Li—Cd; a lithium-carbon intercalation compound; a lithium-graphite intercalation compound; a lithium metal oxide intercalation compound such as LiₓWO₂ or LiMoO₂; a lithium metal sulfide intercalation compound such as LiTiS₂; a mixture thereof, or a mixture thereof with an alkali metal, but the anode material is not limited thereto.

As an example of the present disclosure, the cathode may include a transition metal oxide, a transition metal chalcogenide, a poly(carbon disulfide) polymer, an organic-disulfide redox polymer, polyaniline, an organic-disulfide/polyaniline complex, or a mixture of oxychloride and one or more of the materials mentioned, but the cathode material is not limited thereto.

According to one embodiment of the present disclosure, a primary battery including a non-aqueous liquid electrolyte containing the anion receptor of the present disclosure includes:

(i) an anode including lithium, a lithium alloy, a lithium-carbon intercalation compound, a lithium-graphite intercalation compound, a lithium metal oxide intercalation compound, a mixture containing these, or an alkali metal;

(ii) a cathode including a transition metal oxide, a transition metal chalcogenide, a poly(carbon disulfide) polymer, an organo-disulfide redox polymer, a polyaniline, an organo-disulfide/polyaniline complex, or oxychloride, for example, a cathode including SO₂, CuO, CuS, Ag₂CrO₄, I₂, PbI₂, PbS, SOCl₂, V₂O₅, MoO₃, MnO₂, or polycarbonmonofluoride (CF)ₙ;

(iii) the non-aqueous liquid electrolyte of the present disclosure described above; and

(iv) a separator,

and the anode, the cathode, and the battery can be manufactured using a known assembling method.

According to one embodiment of the present disclosure, a secondary battery including a non-aqueous liquid electrolyte containing the anion receptor of the present disclosure includes:

(i) an anode including: lithium; a lithium alloy such as Li—Al, Li—Si, and Li—Cd; a lithium-carbon intercalation compounds; a lithium-graphite intercalation compound; a lithium metal oxide intercalation compound such as LixWO₂ or LiMoO₂; or lithium metal or a material on which lithium metal can reversibly act, for example, a lithium metal intercalation compound such as LiTiS₂;

(ii) a cathode including: a transition metal oxide capable of intercalating lithium, such as Li_{2.5}V₆O₁₃, Li_{1.2}V₂O₅, LiCoO₂, LiNiO₂, LiNi₁₋ₓMₓO₂ (where M is Co, Mg, Al or Ti), LiMn₂O₄, or LiMnO₂; a transition metal halide; or a chalcogenide such as LiNbSe₃, LiTiS₂, or LiMoS₂;

(iii) the non-aqueous liquid electrolyte of the present disclosure described above; and

(iv) a separator. The anode and cathode can be manufactured by a known method, and the battery can be assembled by a known assembling method.

According to one embodiment of the present disclosure, a secondary battery including a gel-type polymer electrolyte containing the anion receptor of the present disclosure may include the anode, cathode, and separator that are used in the non-aqueous liquid electrolyte-containing secondary battery described above, and the gel-type polymer electrolyte of the present disclosure.

According to one embodiment of the present disclosure, a secondary battery including a solid polymer electrolyte containing the anion receptor of the present disclosure may include the anode and cathode that are used in the non-aqueous liquid electrolyte-containing secondary battery described above, and the solid polymer electrolyte of the present disclosure.

According to one embodiment of the present disclosure, the battery is a battery using an electrolyte containing a non-aqueous solvent. For example, the battery may be a lithium ion battery, a lithium ion polymer battery, an alkali metal battery, etc., but is not limited thereto.

According to an embodiment of the present disclosure, the battery can be recycled by replacing the electrolyte included in the battery.

The present disclosure relates to a recycle battery manufactured using the anion receptor of the present disclosure.

According to an embodiment of the present disclosure, the recycle battery may be a reusable battery recycled by replacing the electrolyte in a waste battery (for example, an electric vehicle battery) with a new anion receptor-containing electrolyte. That is, the recycle battery may be composed of components recovered from waste batteries and an electrolyte containing the anion receptor of the present disclosure.

According to one embodiment of the present disclosure, the recycle battery is manufactured by a method of replacing the electrolyte in a waste battery with an anion receptor-containing electrolyte of the present disclosure, and the method including:

(i) preparing a waste battery;

(ii) removing a waste electrolyte and other impurities included in the waste battery; and

(iii) regenerating the waste battery by injecting the electrolyte of the present disclosure.

As an example of the present disclosure, the step of preparing a waste battery and the step of removing a waste electrolyte and impurities included in the waste battery may be performed in a dry room or an inert atmosphere.

As an example of the present disclosure, the step of removing a waste electrolyte and impurities included in the waste battery may be performed in vacuum conditions.

As an example of the present disclosure, the step of regenerating the waste battery by injecting the electrolyte of the present disclosure may use a method of vibrating the waste battery at a certain temperature after injecting a new electrolyte into the waste battery, in which the temperature may be in a range of 20° C. to 50° C.

According to an embodiment of the present disclosure, the recycle battery and its manufacturing method are configured such that the waste electrolyte in a waste electric vehicle battery (waste battery) is replaced with an anion receptor-containing electrolyte of the present disclosure. For example, in the case of waste batteries used for electric vehicles, there is a high risk of explosion and fire in a charged state.

Therefore, it is necessary to completely discharge the waste batteries before a recycling process. After the waste batteries are completely discharged, each battery back is disassembled into individual cells. Each discharged cell can be classified according to its charge capacity and discharge capacity evaluated using a charging and discharging device.

For example, the cells are divided into cells with a capacity of 80% or more, cells with a capacity of 68% to 80%, and cells with a capacity of 68% or less, and a regeneration process is performed on the cells with a capacity of 68% or less which is excessively low. These cells are then completely discharged, and then punched in a dry room or inert atmosphere environment, so that the existing electrolyte, generated gases, and impurities can be removed through the holes of the cells. Afterwards, an electrolyte containing an additive that can restore performance is injected into each of the cells, the hole is plugged, and each of the cells is shaken for a certain period of time at a predetermined temperature (in a range of 25° C. to 50° C.) to evenly distribute the newly injected electrolyte, thereby activating the anode/cathode active material, the activity of Li ions, and restoring the cell capacity.

Hereinafter, the present disclosure will be described in more detail with reference to examples and comparative examples. However, the examples described below are provided only to aid understanding of the present disclosure and thus should not be construed as limiting to the scope of the present disclosure.

### Preparation Example 1

### Synthesis of N-allyl-(bis-trifluoromethanesulfonyl)imide (allyl-TFSI)

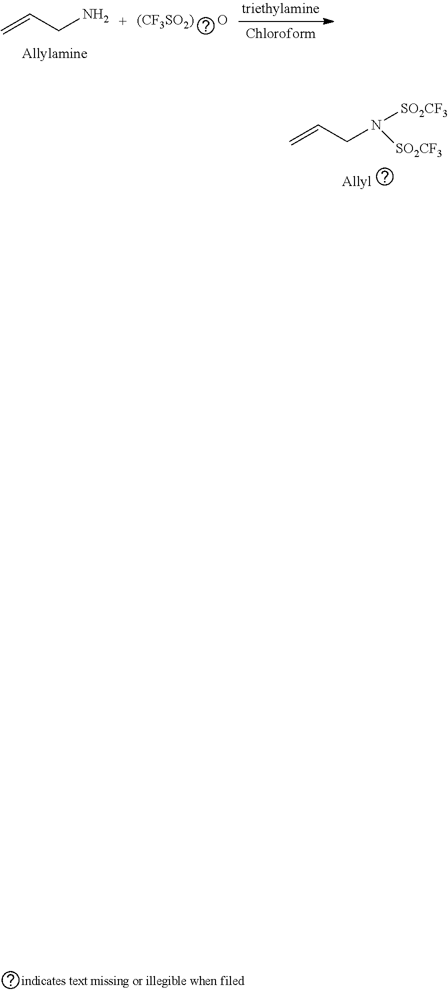

To a mixture prepared by mixing allylamine (0.5 g, 8.76 mmol) and triethylamine (2.0 g, 20 mmol) with 40 ml of chloroform at −40° C., 5.0 g of triflic anhydride (18 mmol) was added dropwise in a nitrogen atmosphere. The resulting solution was stirred at room temperature for 4 hours, and volatiles were removed under reduced pressure. The remaining viscous liquid was dissolved in 30 ml of 4 M NaOH and washed three times with 25 ml of chloroform. The aqueous component was neutralized with HCl, and then washed again three times with 30 ml of chloroform. Next, the resulting organic extract was dried over anhydrous MgSO₄ and filtered. Chloroform was removed under vacuum to obtain a product (N-allyl-(bis-trifluoromethane sulfonyl)imide: Allyl-TFSI).

¹H NMR (300 MHz, CDCl₃): ppm 3.32 (m, 2H), 5.15 (m, 1H), 5.83 (m, 111); ¹³C NMR (300 MHz, CDCl₃): 40, 114.9, 134.3, 145.9; ¹⁹F NMR (CDCl₃): ppm −79.8 (s).

### Preparation Example 2

### Synthesis of N-allyl-trifluoromethanesulfonamide (allyl-TFSA)

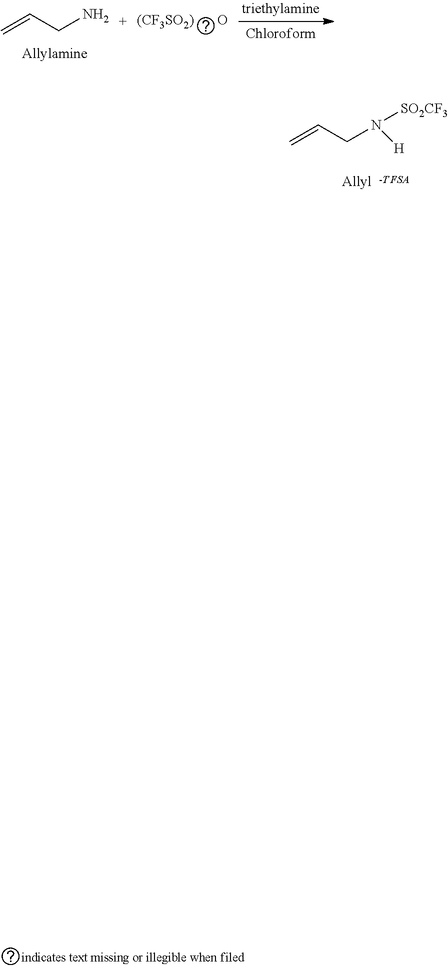

To a mixture prepared by mixing allylamine (1 g, 17.5 mmol) and triethylamine (2.0 g, 20 mmol) with 40 ml of chloroform at −40° C., 5.0 g of triflic anhydride (18 mmol) was added dropwise in a nitrogen atmosphere. The resulting solution was stirred at room temperature for 4 hours, and volatiles were removed under reduced pressure. The remaining viscous liquid was dissolved in 30 ml of 4 M NaOH and washed three times with 25 ml of chloroform. The aqueous component was neutralized with HCl, and then washed again three times with 30 ml of chloroform. Next, the resulting organic extract was dried over anhydrous MgSO₄ and filtered. Chloroform was removed under vacuum to obtain a product (N-allyl-trifluoro-methanesulfonamide: Allyl-TFSA).

¹H NMR (300 MHz, CDCl₃): ppm 3.9 (m, 2H), 4.9 (s-broad, 1H), 5.35 (m, 2H), 5.9 (m, 1H); ¹⁹F NMR (CDCl₃): ppm -77.9 (s); IR: _{νN-H} 3315 cm⁻¹.

### Preparation Example 3

### Synthesis of N-allyl-trifluoroacetamide

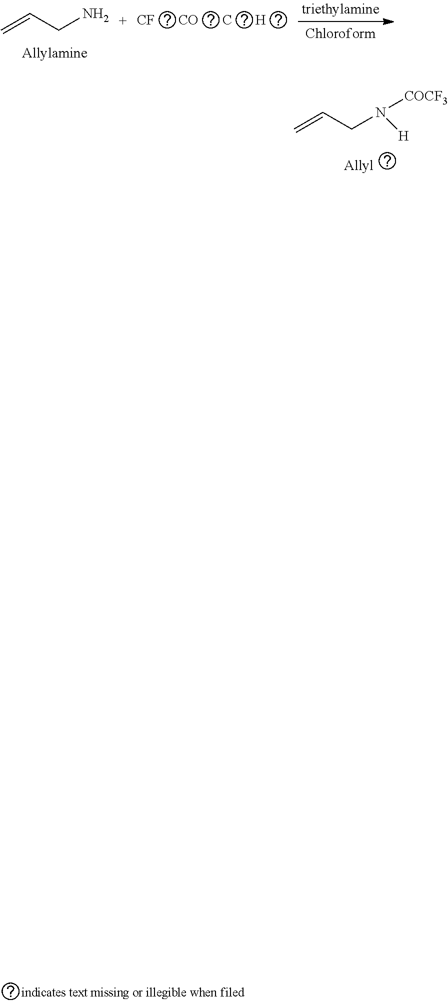

To a mixture prepared by mixing allylamine (1 g, 17.5 mmol) and triethylamine (2.0 g, 20 mmol) with 40 ml of chloroform at −40° C., 2.5 g of ethyl trifluoroacetate (17.6 mmol) was added dropwise in a nitrogen atmosphere. The resulting solution was stirred at room temperature for 4 hours, and volatiles were removed under reduced pressure. Chloroform was removed under vacuum to obtain a product (N-allyl-trifluoroacetamide, N-allyl-2,2,2-trifluoro-acetamide: Allyl-TFAc).

¹H NMR (300 MHz, CDCl₃): ppm 3.9 (m, 2H), 5.15 (s-broad, 1H), 5.83 (m, 2H), 5.9 (m, 1H); ¹³C NMR (300 MHz, CDCl₃): 46, 114.9, 134.3, 125.4, 171.2; ¹⁹F NMR (CDCl₃): ppm −77.2(s); IR: _{νN-H} 3315 cm⁻¹.

### Preparation Example 4

### Synthesis of N-allyl-2,2,2-trifluoro-N-trifluoroacetyl-acetamide

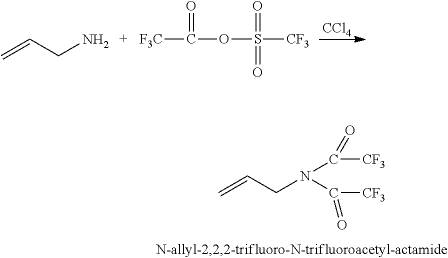

Allylamine (0.119 g, 2.08 mmol), trifluoroacetic anhydride (0.49 mL, 3.2 mmol), and 2,6-di-tertiary-butyl-4-methyl-pyridine (0.637 g, 3.11 mmol) dissolved in 3 ml of carbon tetrachloride were reacted for 4 hours, and pyridinium triflate was filtered out. Thus, a product (N-allyl-2,2,2-trifluoro-N-trifluoroacetyl-acetamide (N-allyl-2,2,2-trifluoro-N-trifluoroacetyl-acetamide) was obtained.

¹H NMR (300 MHz, CDCl₃): ppm 4.37 (m, 2H), 5.07-5.26 (m, 2H), 5.80 (m, 1H); ¹³C NMR (CDCl₃): ppm 43.0, 116.9, 122.9, 132.3, 167.2; ¹⁹F NMR (CDCl₃): ppm −79.2 (s).

### Example 1-1

### Synthesis of 2,2,2-trifluoro-N-(3-{1-[3-(2,2,2-trffiuoro-acetylamino)-propyl]-2,5-dihydro-1H-silole-1-yl}-propyl)-acetamide (Compound 1-1)

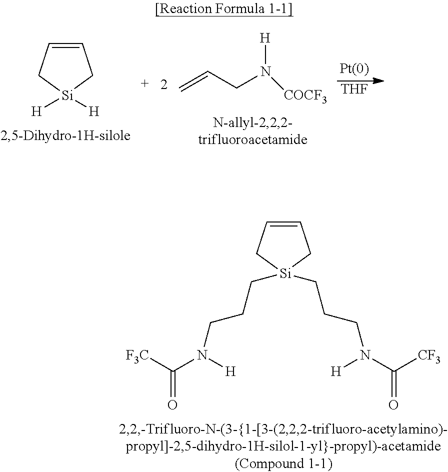

According to Reaction Formula 1-1,2,5-dihydro-1H-silole (8.42 g, 0.1 mol), Pt(O)-1,3-divinyl-1,1,3,3-tetramethyldisiloxane complex (Pt(O)) catalyst, and N-allyl-2,2,2-trifluoroacetamide (30.61 g, 0.2 mol) were dissolved in 50 ml of tetrahydrofuran and added dropwise. The solution was refluxed at 65° C. for 8 hours in a nitrogen atmosphere, cooled to room temperature, added and mixed with activated carbon under stirring, and filtered. Tolun was then removed by evaporation under reduced pressure to produce a product (2,2,2-trifluoro-N-(3-{1-[3-(2,2,2-trifluoro-acetylamino)-propyl]-2,5-dihydro-1H-silole-1-yl}-propyl)-acetamide (Compound 1-1).

¹H NMR (300 MHz, CDCbl₃: ppm 0.62(m, 4H), 1.6(m, 4H), 3.2(m, 4H), 5.42 (m, 2H), 7.38(m, 2H); ¹³ C NMR (300 MHz, CDCl₃): ppm 9.0, 13.0, 27.1, 46.0, 125.3, 170.9; ¹⁹F NMR (CDCl₃): ppm −77.4 (s); IR: _{νN-H} 3315 cm⁻¹.

### Example 1-2

### Synthesis of C,C,C,-trffiuoro-N-{(3[1-(3-trifluoromethanesulfonylamino-propyl)-2,5-dihydro-1H-silole-1-yl]propyl}-methanesulfonamide (Compound 1-2)

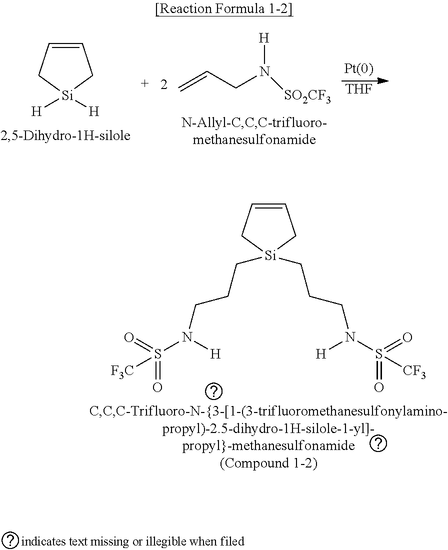

According to [Reaction Formula 1-2], 2,5-dihydro-1H-silole (8.42 g, 0.1 mol), Pt(O)-1,3-divinyl-1,1,3,3-tetramethyldi A siloxane complex (Pt(O)) catalyst, and N-allyl-C,C,C-trifluoromethanesulfonamide (37.82 g, 0.2 mol) were reacted under the same conditions as in Reaction Formula 1-1 of Example 1-1 to produce a product (C,C,C,-trifluoro-N-{(3-[1-(3-trifluoromethanesulfonylamino-propyl)-2,5-dihydro-1H-silole-1-yl]-Propyl}-methanesulfonamide) (Compound 1-2).

¹H NMR (300 MHz, CDCl₃): ppm 0.62 (m, 4H), 1.6 (m, 4H), 1.29 (m, 4H), 2.65 (m, 4H), 5.42 (m, 2H), 7.54 (m, 2H); ¹³C NMR (300 MHz, CDCl₃): ppm 9.0, 13.0, 26.2, 44.0, 125.3, 149.4; ¹⁹F NMR (CDCl₃): ppm −78.3 (s); IR: _{νN-H} 3315 cm⁻¹.

### Example 1-3

### Synthesis of 2,2,2,-trifluoro-N-{(3-[1-(3-trifluoromethanesulfonylamino-propyl)-2,5-dihydro-1H-silole-1-yl]propyl}-acetamide (Compound 1-3)

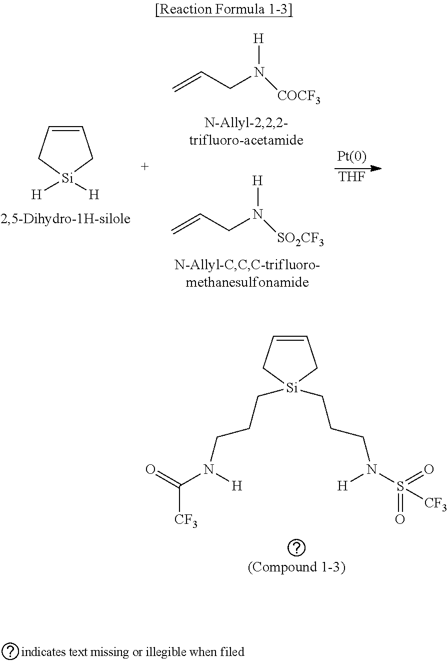

2,5-dihydro-1H-silole (8.42 g, 0.1 mol), Pt(O)-1,3-divinyl-1,1,3,3-tetramethyldisiloxane complex (Pt(O)) catalyst, N-allyl-2,2,2-trifluoroacetamide (15.31 g, 0.1 mol), and N-allyl-C,C,C-trifluoromethanesulfonamide (18.91 g, 0.1 mol) were reacted under the same conditions as Reaction Formula 1-1 of Example 1-1 to produce a product (2,2,2,-trifluoro-N-{(3-[1-(3-trifluoromethanesulfonylamino-propyl)-2,5-dihydro-1H-silole-1-yl]-propyl}-acetamide) (Compound 1-3)).

¹H NMR (300 MHz, CDCl₃): ppm 0.62 (m, 4H), 1.6 (m, 4H), 1.29 (m, 4H), 2.65 (m, 4H), 5.42 (m, 2H), 7.38 (m, 1H), 7.54 (m, 1H); ¹³C NMR (300 MHz, CDCl₃): ppm 9.0, 13.0, 26.2, 44.0, 125.3, 149.4, 170.9; ¹⁹F NMR (CDCl₃): ppm −78.5 (s); IR: _{νN-H} 3315 cm⁻¹.

### Example 1-4

### Synthesis of N-[3-(1-{3-[bis-(2,2,2-trifluoro-acetyl)-amino]-propyl}-2,5-dihydro-1H-silole-1-yl)-propyl]-2,2,2-trifluoro-N-(2,2,2-trffiuoroacetyl)-acetamide (Compound 1-4)

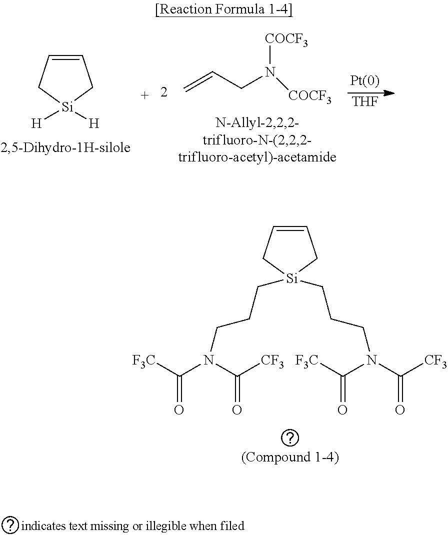

According to [Reaction Formula 1-4], 2,5-dihydro-1H-silole (8.42 g, 0.1 mol), Pt(O)-1,3-divinyl-1,1,3,3-tetramethyldi A siloxane complex (Pt(O)) catalyst, and N-allyl-2,2,2-trifluoroacetamide (49.82 g, 0.2 mol) were reacted under the same conditions as Reaction Formula 1-1 of Example 1-1 to produce a product (N-[3-(1-{3-[bis-(2,2,2-trifluoro-acetyl)-amino]-propyl}-2,5-dihydro-1H-silole-1-yl)-propyl]-2,2,2-trifluoro-N-(2,2,2-trifluoroacetyl)-acetamide) (Compound 1-4).

¹H NMR (300 MHz, CDCl₃): ppm 0.62 (m, 4H), 1.29 (m, 4H), 1.6 (m, 4H), 3.48 (m, 4H), 5.42 (m, 2H); ¹³C NMR (300 MHz, CDCl₃): ppm 9.0, 13.0, 24.4, 44.0, 122.6, 125.3, 168.9; ¹⁹F NMR (CDCl₃): ppm −79.2 (s).

### Example 1-5

### Synthesis of N-[3-(1-{3-[bis-(2,2,2-trifluoro-acetyl)-amino]-propyl}-2,5-dihydro-1H-silole-1-yl)-propyl]-N-{3-[bis-(2,2,2-trffiuoromethanesulfonyl)-amino]-propyl}-methanesulfonamide (Compound 1-5)

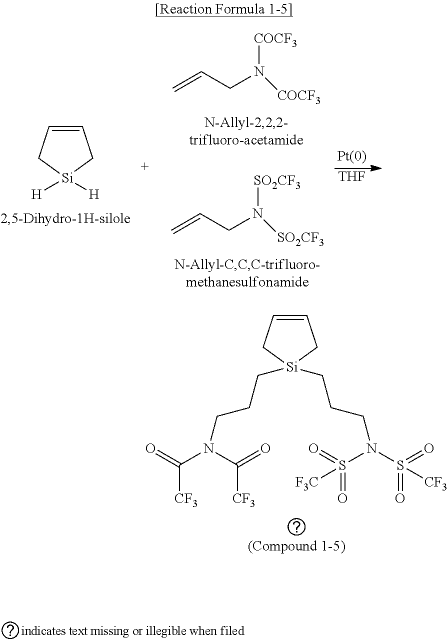

2,5-dihydro-1H-silole (8.42 g, 0.1 mol), Pt(O)-1,3-divinyl-1,1,3,3-tetramethyldisiloxane complex (Pt(O)) catalyst, N-allyl-2,2,2-trifluoroacetamide (24.91 g, 0.1 mol), and N-allyl-C,C,C-trifluoromethanesulfonamide (32.12 g, 0.1 mol) were reacted under the same conditions as Reaction Formula 1-1 in Example 1-1 to produce a product (N-[3-(1-{3-[bis-(2,2,2-trifluoro-acetyl)-amino]-propyl}-2,5-dihydro-1H-silole-1-yl)-propyl]-{3-[bis-(2,2,2-trifluoromethanesulfonyl)-amino]-propyl}-methane sulfonamide) (Compound 1-5).

¹H NMR (300 MHz, CDCl₃): ppm 0.62 (m, 4H), 1.6 (m, 4H), 1.29 (m, 4H), 2.65 (m, 2H), 3.48 (m, 2H), 5.42 (m, 2H); ¹³C NMR (300 MHz, CDCl₃): ppm 9.0, 13.0, 22.6, 24.4, 40.0, 44.0, 122.6, 125.3, 145.8, 168.9; ¹⁹F NMR (CDCl₃): ppm −79.5(s).

### Example 1-6

### Synthesis of N-[3-(1-{3-[bis-(2,2,2-trifluoromethanesulfonyl)-amino]-propyl}-2,5-dihydro-1H-silole-1-yl)-propyl]-N-{3-[bis-(2,2,2-trifluoromethanesulfonyl)-amino]-propyl}-methanesulfonamide (Compound 1-6)

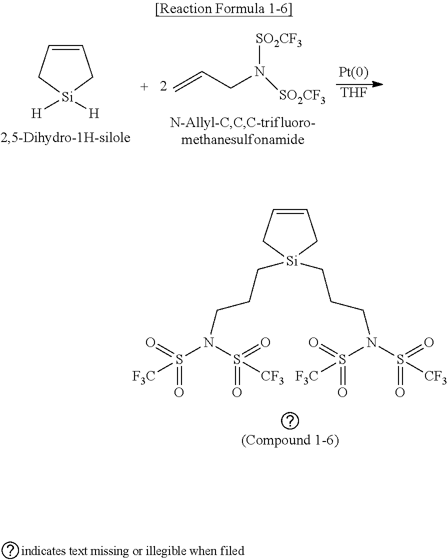

2,5-dihydro-1H-silole (8.42 g, 0.1 mol), Pt(O)-1,3-divinyl-1,1,3,3-tetramethyldisiloxane complex (Pt(O)) catalyst, and N-allyl-C,C,C-trifluoromethanesulfonamide (64.24 g, 0.2 mol) were reacted under the same conditions as Scheme 1-1 in Example 1-1 to produce a product (N-[3-(1-{3-[bis-(2,2,2-trifluoromethanesulfonyl)-amino]-propyl}-2,5-dihydro-1H-silole-1-yl)-propyl]-N-{3-[bis-(2,2,2-trifluoromethanesulfonyl)-amino]-propyl}-methanesulfonamide) (Compound 1-6).

¹H NMR (300 MHz, CDCl₃): ppm 0.62 (m, 4H), 1.6 (m, 4H), 1.29 (m, 4H), 2.65 (m, 4H), 5.42 (m, 2H); ¹³C NMR (300 MHz, CDCl₃): ppm 9.0, 13.0, 22.6, 40.0, 122.6, 145.8; ¹⁹F NMR (CDCl₃): ppm −79.9 (s).

### Example 2-1

### Synthesis of 2,2,5,5-tetramethyl-1-trffiuoromethanesulfonyl-2,5-clihydro-1-H-[1,2,5]-azaclisilol (Compound 2-1)

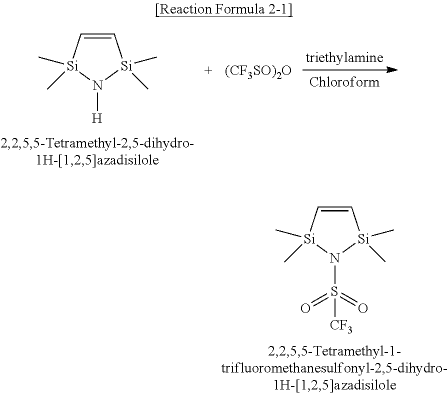

According to [Reaction Formula 2-1], To a mixture prepared by mixing 2,2,5,5-tetramethyl-2,5-dihydro-1H-[1,2,5]azadisilole(2.75 g, 17.5 mmol) and triethylamine (2.0 g, 20 mmol) with 40 ml of chloroform at −40° C., 5.0 g of triflic anhydride (18 mmol) was added dropwise in a nitrogen atmosphere. The resulting solution was stirred at room temperature for 4 hours, and volatiles were removed under reduced pressure. The remaining viscous liquid was dissolved in 30 ml of 4 M NaOH and washed three times with 25 ml of chloroform. The aqueous component was neutralized with HCl, and then washed again three times with 30 ml of chloroform. Next, the resulting organic extract was dried over anhydrous MgSO₄ and filtered. Chloroform was removed under vacuum to produce a product (2,2,5,5-tetramethyl-1-trifluoromethanesulfonyl-2,5-dihydro-1-H-[1,2,5]-azadisilol) (Compound 2-1).

¹H NMR (300 MHz, CDCl₂): ppm 0.14 (m, 4H), 5.2 (m, 2H); ¹³ C NMR (CDCl₃): ppm 0, 123, 153.4; ¹⁹F NMR (CDCl₃): ppm −77.8 (s)

### Example 2-2

### Synthesis of 2,2,2-trffiuoro-1-(2,2,5,5-tetramethyl-2,5-dihydro-[1,2,5]azaclisilole-1-yl)-ethanone (Compound 2-2)

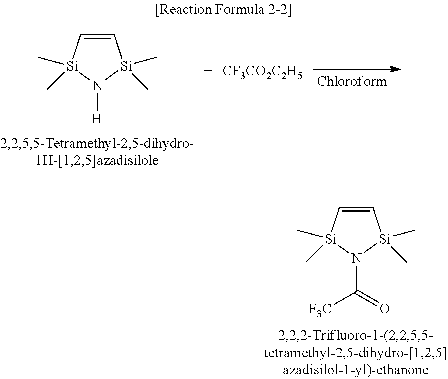

To a mixture prepared by mixing 2,2,5,5-tetramethyl-2,5-dihydro-1H-[1,2,5]azadisilol (2.75 g, 17.5 mmol) and triethylamine (2.0 g, 20 mmol) with 40 ml of chloroform at −40° C., ethyl trifluoroacetate (2.5 g, 17.6 mmol) was added dropwise in a nitrogen atmosphere. The resulting solution was stirred at room temperature for 4 hours, and volatiles were removed under reduced pressure. Chloroform was removed under vacuum to produce a product (2,2,2-trifluoro-1-(2,2,5,5-tetramethyl-2,5-dihydro-[1,2,5]azadisilole-1-yl)-ethanone) (Compound 2-2).

¹H NMR (300 MHz, CDCl₃): ppm 0.14 (m, 4H), 5.2 (m, 2H); ¹³C NMR (300 MHz, CDCl₃): 0, 123, 129.3, 173; ¹⁹F NMR (CDCl₃): ppm −77.3 (s)

### Example 3-1

### Synthesis of 2,2,5,5-tetramethyl-1-trifluoromethanesulfonyl-[1,2,5]azaclisilolicline (Compound 3-1)

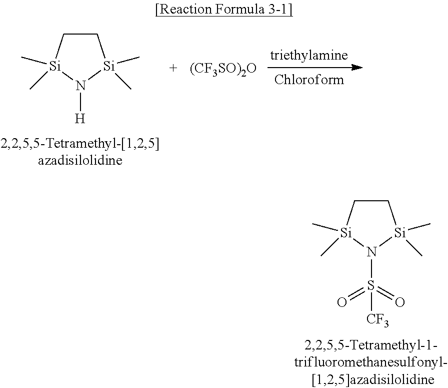

To a mixture prepared by mixing 2,2,5,5-tetramethyl-[1,2,5]azadisilolidine (2.79 g, 17.5 mmol) and triethylamine (2.0 g, 20 mmol) with 40 ml of chloroform at −40° C., 5.0 g (18 mmol) of triflic anhydride was added dropwise in a nitrogen atmosphere. The resulting solution was stirred at room temperature for 4 hours, and volatiles were removed under reduced pressure. The remaining viscous liquid was dissolved in 30 ml of 4 M NaOH and washed three times with 25 ml of chloroform. The aqueous component was neutralized with HCl, and then washed again three times with 30 ml of chloroform. Next, the resulting organic extract was dried over anhydrous MgSO₄ and filtered. Chloroform was removed under vacuum to obtain a product (2,2,5,5-Tetramethyl-1-trifluoromethanesulfonyl-[1,2,5]azadisilolidine) (Compound 3-1).

¹H NMR (300 MHz, CDCl₃): ppm 0.08 (m, 4H), 1.4 (m, 2H); ¹³ C NMR (CDCl₃): ppm 0, 13.7, 153.6; ¹⁹F NMR (CDCl₃): ppm −77.7 (s)

### Example 3-2

### Synthesis of 2,2,2-trifluoro-1-(2,2,5,5-tetramethyl-[1,2,5]azadisilolidin-1-yl)-ethanone (Compound 3-2)

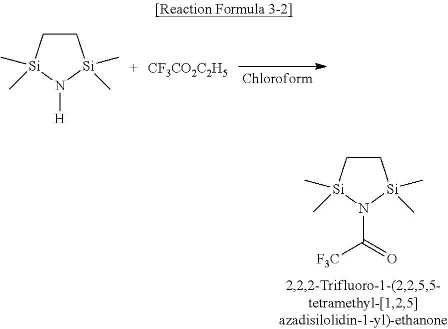

To a mixture prepared by mixing 2,2,5,5-tetramethyl-[1,2,5]azadisilol (2.75 g, 17.5 mmol) and triethylamine (2.0 g, 20 mmol) with 40 ml of chloroform at −40° C., ethyltrifluoroacetate (2.5 g, 17.6 mmol) was added dropwise in a nitrogen atmosphere. The resulting solution was stirred at room temperature for 4 hours, and volatiles were removed under reduced pressure. Chloroform was removed under vacuum to produce a product (2,2,2-trifluoro-1-(2,2,5,5-tetramethyl-[1,2,5]azadisilolidin-1-yl)-ethanone) (Compound 3-2).

¹H NMR (300 MHz, CDCl₃): ppm 0.08 (m, 4H), 1.4 (m, 2H); ¹³C NMR (300 MHz, CDCl₃): 0, 14.6, 129.5, 173; ¹⁹ F NMR (CDCl₃): ppm −77.4 (s)

### Example 4

### Manufacturing of Ion Conductive Thin Film (1)

The anion receptor compound 1-1 (0.25 g) prepared in Example 1-1 was mixed with bisphenol A ethoxylate dimethacrylate represented by Formula 15 (purchased from Aldrich, Mw=1,700, “BIS-15m”, 0.25 g), poly(ethylene glycol) dimethyl ether (Mw=350, “PEGDME 300”, 0.5 g), and lithium trifluoromethanesulfonimide (Li(CF₃SO₂)₂N, 0.7809 g). To this mixture, dimethylphenyl acetophenone (DMPA, 0.0075 g) was added. The resulting mixture solution was applied to a conductive glass substrate and then exposed to ultraviolet rays with a wavelength of 350 nm for 30 minutes in a nitrogen atmosphere. A solid polymer membrane was produced through the light irradiation.

### Example 5

### Manufacturing of Ion Conductive Thin Film (2)

The anion receptor compound 1-2 (0.25 g) prepared in Example 1-2 and lithium trifluoromethanesulfonimide (0.7234 g) were mixed with bisphenol A ethoxylate dimethacrylate represented by Formula 15 and serving as a crosslinking agent, poly(ethylene glycol) dimethyl ether, and dimethylphenyl acetophenone in the same amounts as in Example 4. A solid polymer membrane was thus prepared in the same manner as in Example 4.

### Example 6

### Manufacturing of Ion Conductive Thin Film (3)

The anion receptor compound 1-3 (0.25 g) prepared in Example 1-3 and lithium trifluoromethanesulfonimide (0.7499 g) were mixed with bisphenol A ethoxylate dimethacrylate represented by Formula 15 and serving as a crosslinking agent, poly(ethylene glycol) dimethyl ether, and dimethylphenyl acetophenone in the same amounts as in Example 4. A solid polymer membrane was thus prepared in the same manner as in Example 4.

### Example 7

### Manufacturing of Ion Conductive Thin Film (4)

The anion receptor compound 1-4 (0.25 g) prepared in Example 1-4 and lithium trifluoromethanesulfonimide (0.6597 g) were mixed with bisphenol A ethoxylate dimethacrylate represented by Formula 15 and serving as a crosslinking agent, poly(ethylene glycol) dimethyl ether, and dimethylphenyl acetophenone in the same amounts as in Example 4. A solid polymer membrane was thus prepared in the same manner as in Example 4.

### Example 8

### Manufacturing of Ion Conductive Thin Film (5)

The anion receptor compound 1-5 (0.25 g) prepared in Example 1-5 and lithium trifluoromethanesulfonimide (0.6237 g) were mixed with bisphenol A ethoxylate dimethacrylate represented by Formula 15 and serving as a crosslinking agent, poly(ethylene glycol) dimethyl ether, and dimethylphenyl acetophenone in the same amounts as in Example 4. A solid polymer membrane was thus prepared in the same manner as in Example 4.

### Example 9

### Manufacturing of Ion Conductive Thin Film (6)

The anion receptor compound 1-6 (0.25 g) prepared in Example 1-6 and lithium trifluoromethanesulfonimide (0.6109 g) were mixed with bisphenol A ethoxylate dimethacrylate represented by Formula 15 and serving as a crosslinking agent, poly(ethylene glycol) dimethyl ether, and dimethylphenyl acetophenone in the same amounts as in Example 4. A solid polymer membrane was thus prepared in the same manner as in Example 4.

### Example 10

### Manufacturing of Ion Conductive Thin Film (7)

The anion receptor compound 2-1 (0.25 g) prepared in Example 2-1 and lithium trifluoromethanesulfonimide (0.4548 g) were mixed with bisphenol A ethoxylate dimethacrylate represented by Formula 15 and serving as a crosslinking agent, poly(ethylene glycol) dimethyl ether, and dimethylphenyl acetophenone in the same amounts as in Example 4. A solid polymer membrane was thus prepared in the same manner as in Example 4.

### Example 11

### Manufacturing of Ion Conductive Thin Film (8)

The anion receptor compound 2-2 (0.25 g) prepared in Example 2-2 and lithium trifluoromethanesulfonimide (0.4846 g) were mixed with bisphenol A ethoxylate dimethacrylate represented by Formula 15 and serving as a crosslinking agent, poly(ethylene glycol) dimethyl ether, and dimethylphenyl acetophenone in the same amounts as in Example 4. A solid polymer membrane was thus prepared in the same manner as in Example 4.

### Example 12

### Manufacturing of Ion Conductive Thin Film (9)

The anion receptor compound 3-1 (0.25 g) prepared in Example 3-1 and lithium trifluoromethanesulfonimide (0.4530 g) were mixed with bisphenol A ethoxylate dimethacrylate represented by Formula 15 and serving as a crosslinking agent, poly(ethylene glycol) dimethyl ether, and dimethylphenyl acetophenone in the same amounts as in Example 4. A solid polymer membrane was thus prepared in the same manner as in Example 4.

### Example 13

### Manufacturing of Ion Conductive Thin Film (10)

The anion receptor compound 3-2 (0.25 g) prepared in Example 3-2 and lithium trifluoromethanesulfonimide (0.4877 g) were mixed with bisphenol A ethoxylate dimethacrylate represented by Formula 15 and serving as a crosslinking agent, poly(ethylene glycol) dimethyl ether, and dimethylphenyl acetophenone in the same amounts as in Example 4. A solid polymer membrane was thus prepared in the same manner as in Example 4.

### Comparative Example 1

### Manufacturing of Thin Film without Anion Receptor

A solid polymer membrane was prepared in the same manner as in Example 2, with the compound composition as shown in Table 1 above. As shown in Table 1, the polymer electrolyte of the comparative example does not contain an anion receptor.

TABLE 1
(Unit: g)

| | | Crosslinking | | | | |
|---|---|---|---|---|---|---|
| | | agent | Anion | Plasticizer | Lithium salt | Initiator |
| | | (Bis-15m) | receptor | (PEGDME) | (Li(CF₃SO₂)₂N) | (DMPA) |
| | Compound | Usage | Usage | Usage | Usage | Usage |
| Example 4 | Compound 1-1 | 0.25 | 0.25 | 0.5 | 0.7809 | 0.075 |
| Example 5 | Compound 1-2 | | | | 0.7234 | |
| Example 6 | Compound 1-3 | | | | 0.7499 | |
| Example 7 | Compound 1-4 | | | | 0.6597 | |
| Example 8 | Compound 1-5 | | | | 0.6327 | |
| Example 9 | Compound 1-6 | | | | 0.6109 | |
| Example 10 | Compound 2-1 | | | | 0.4548 | |
| Example 11 | Compound 2-2 | | | | 0.4846 | |
| Example 12 | Compound 3-1 | | | | 0.4530 | |
| Example 13 | Compound 3-2 | | | | 0.4877 | |
| Comparative | — | | — | | 0.2067 | |
| Example 1 | | | | | | |

### Experimental Example 1

### Ionic Conductivity Experiment (1)

A solid polymer electrolyte thin film was prepared as in Example 4 using Compound 1-1, which is an anion receptor prepared in Example 1-1 according to the present disclosure, and ionic conductivity thereof was measured. Ion conductivity was measured by a method described below.

The solid polymer electrolyte composition was applied on a band-shaped conductive glass substrate or lithium-copper foil, then photo-cured, and then sufficiently dried. Next, the AC impedance between the band-type or sandwich-type electrodes was measured in a nitrogen atmosphere, and the measured value was analyzed with a frequency response analyzer and obtained by impedance spectroscopy.

The band-type electrode was prepared by attaching masking tape with a width of 0.5 to 2 mm to the center of a conductive glass plate (ITO) at intervals of about 0.5 to 2 mm, placing the plate in an etching solution, and washing and drying the plate. The ionic conductivity of the manufactured solid polymer membrane was measured at different temperatures, and the results are shown in Table 2.

### Experimental Example 2

### Ionic Conductivity Experiment (2)

For the solid polymer electrolyte membrane of Example 5 having the composition shown in Table 1 and prepared using Compound 1-2, which is the anion receptor prepared in Example 1-2, the ionic conductivity was measured in the same manner as in Experimental Example 1. The results of measuring ionic conductivity at a temperature of 30° C. are shown in Table 2 below.

### Experimental Example 3

### Ionic Conductivity Experiment (3)

For the solid polymer electrolyte membrane of Example 6 having the composition shown in Table 1 and prepared using Compound 1-3, which is the anion receptor prepared in Example 1-3, the ionic conductivity was measured in the same manner as in Experimental Example 1. The results of measuring ionic conductivity at a temperature of 30° C. are shown in Table 2 below.

### Experimental Example 4

### Ionic Conductivity Experiment (4)

For the solid polymer electrolyte membrane of Example 7 having the composition shown in Table 1 and prepared using Compound 1-4, which is the anion receptor prepared in Example 1-4, the ionic conductivity was measured in the same manner as in Experimental Example 1. The results of measuring ionic conductivity at a temperature of 30° C. are shown in Table 2 below.

### Experimental Example 5

### Ionic Conductivity Experiment (5)

For the solid polymer electrolyte membrane of Example 8 having the composition shown in Table 1 and prepared using Compound 1-5, which is the anion receptor prepared in Example 1-5, the ionic conductivity was measured in the same manner as in Experimental Example 1. The results of measuring ionic conductivity at a temperature of 30° C. are shown in Table 2 below.

### Experimental Example 6

### Ionic Conductivity Experiment (6)

For the solid polymer electrolyte membrane of Example 9 having the composition shown in Table 1 and prepared using Compound 1-6, which is the anion receptor prepared in Example 1-6, the ionic conductivity was measured in the same manner as in Experimental Example 1. The results of measuring ionic conductivity at a temperature of 30° C. are shown in Table 2 below.

### Experimental Example 7

### Ionic Conductivity Experiment (7)

For the solid polymer electrolyte membrane of Example 10 having the composition shown in Table 1 and prepared using Compound 2-1, which is the anion receptor prepared in Example 2-1, the ionic conductivity was measured in the same manner as in Experimental Example 1. The results of measuring ionic conductivity at a temperature of 30° C. are shown in Table 2 below.

### Experimental Example 8

### Ionic Conductivity Experiment (8)

For the solid polymer electrolyte membrane of Example 11 having the composition shown in Table 1 and prepared using Compound 2-2, which is the anion receptor prepared in Example 2-3, the ionic conductivity was measured in the same manner as in Experimental Example 1. The results of measuring ionic conductivity at a temperature of 30° C. are shown in Table 2 below.

### Experimental Example 9

### Ionic Conductivity Experiment (9)

For the solid polymer electrolyte membrane of Example 12 having the composition shown in Table 1 and prepared using Compound 3-1, which is the anion receptor prepared in Example 3-1, the ionic conductivity was measured in the same manner as in Experimental Example 1. The results of measuring ionic conductivity at a temperature of 30° C. are shown in Table 2 below.

### Experimental Example 10

### Ionic Conductivity Experiment (10)

For the solid polymer electrolyte membrane of Example 13 having the composition shown in Table 1 and prepared using Compound 3-2, which is the anion receptor prepared in Example 3-2, the ionic conductivity was measured in the same manner as in Experimental Example 1. The results of measuring ionic conductivity at a temperature of 30° C. are shown in Table 2 below.

TABLE 2

| | Ionic conductivity σ(S/cm) |
|---|---|
| Example 4 | 2.54 × 10⁻⁴ |
| Example 5 | 2.35 × 10⁻⁴ |
| Example 6 | 2.44 × 10⁻⁴ |
| Example 7 | 2.16 × 10⁻⁴ |
| Example 8 | 2.06 × 10⁻⁴ |
| Example 9 | 2.05 × 10⁻⁴ |
| Example 10 | 1.99 × 10⁻⁴ |
| Example 11 | 1.48 × 10⁻⁴ |
| Example 12 | 1.58 × 10⁻⁴ |
| Example 13 | 2.54 × 10⁻⁴ |
| Comparative Example 1 | 4.62 × 10⁻⁶ |

The results of the experiments confirmed that the solid polymer electrolytes containing an anion receptor showed higher ionic conductivity than the solid polymer electrolytes not containing an anion receptor. It was confirmed that as the concentration of the anion receptor increases, the ionic conductivity increases.

### Example 14

### Manufacturing of Battery Using Liquid Electrolyte Containing Anion Receptor

The anion receptor compound 1-1 (0.015 g) prepared in Example 1-1 was mixed with 1.0 g of the organic solvent, EC/DMC/EMC (1:1:1, 1M LiPF₆). A battery was manufactured by inserting a polypropylene separator impregnated with the mixture solution between an NMC ternary cathode and a graphite carbon anode in a dry room (humidity: 3% or less) and vacuum-sealing the separator.

### Comparative Example 2

### Manufacturing of Battery Using Liquid Electrolyte not Containing Anion Receptor

A battery was manufactured by assembling a separator impregnated with 1.0 g of the organic solvent, EC/DMC/DEC (1:1:1, 1M LiPF₆), an NMC ternary cathode, and a graphite carbon anode in the same manner as in Example 14.

### Experimental Example 11

### Lithium Cycling Performance Experiment (1)

The lithium cycling performance and efficiency of the batteries manufactured in Example 14 according to the present disclosure and Comparative Example 2 were measured at low temperature (−10° C.) using a charge/discharge test device (Maccor 4000). The charging and discharging were performed at 1 C. The batteries were charged and discharged at a voltage between 3.0 V and 4.2 V with respect to the NMC counter electrode, at a constant current density of 0.6 mA/cm² (charging) and 1.5 mA/cm² (discharging).

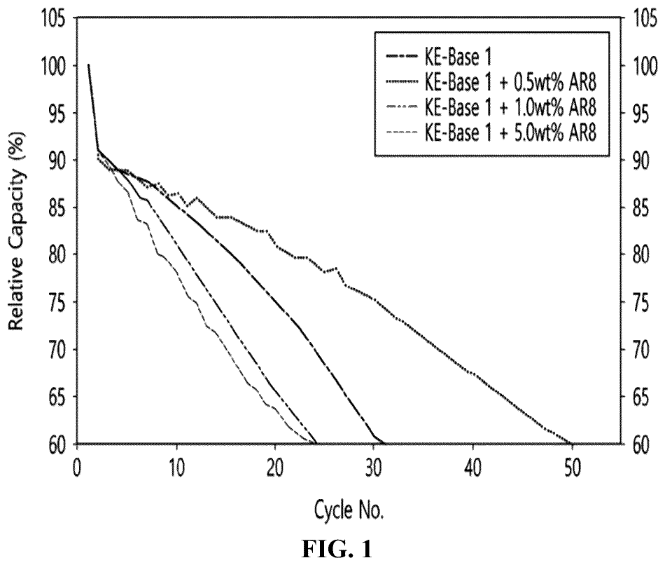

The results of comparison in discharge capacity at low temperature versus the number of cycles of a battery manufactured using an electrolyte containing the anion receptor compound 1-1 (AR8) of the present disclosure and a battery manufactured using an electrolyte not containing the anion receptor are shown in FIG. 1. The battery using an electrolyte containing the anion receptor compound 1-1 (AR8) showed higher capacity than the battery using an electrolyte (KE-Base 1) not containing the anion receptor. In particular, batteries using an electrolyte containing the anion receptor compound 1-1 (AR8) in an amount of 0.5% by weight exhibited excellent stability at low temperatures.

### Experimental Example 12

### Lithium Cycling Performance Experiment

The lithium cycling performance and efficiency of the batteries manufactured in Example 14 according to the present disclosure and Comparative Example 2 were measured at low temperature (−10° C.) using a charge/discharge test device (Maccor 4000). The charging and discharging were performed at 1 C. The batteries were charged and discharged at a voltage between 3.0 V and 4.2 V with respect to the NMC counter electrode, at a constant current density of 0.6 mA/cm² (charging) and 1.5 mA/cm² (discharging).

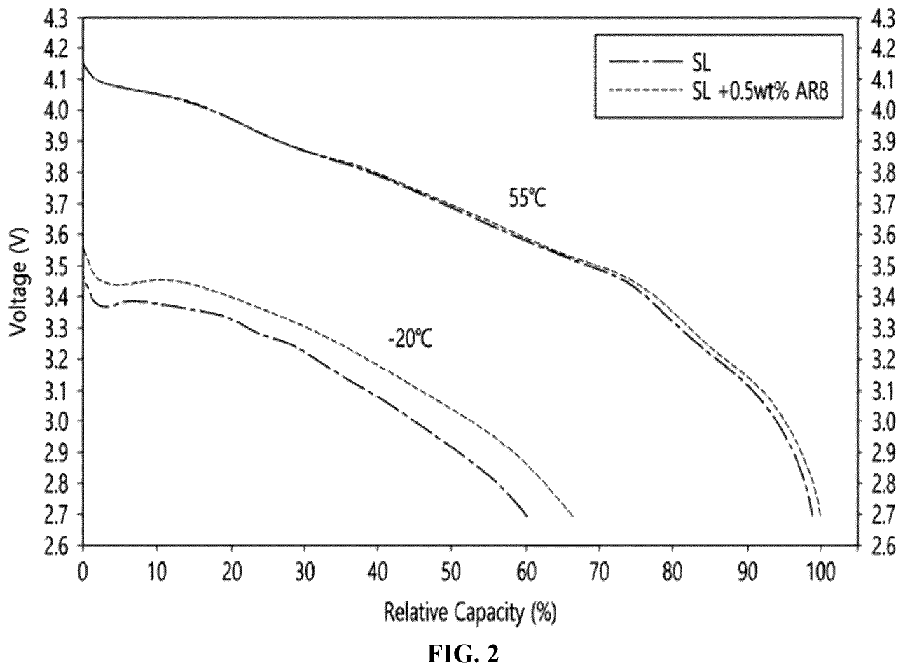

The results of comparison in discharge capacity at high temperature (55° C.) and low temperature (−20° C.) versus the number of cycles of a battery manufactured using an electrolyte containing the anion receptor compound 1-1 (AR8) of the present disclosure and a battery manufactured using an electrolyte not containing the anion receptor are shown in FIG. 2. The batteries using an electrolyte containing the anion receptor compound 1-1 (AR8) showed higher voltage performance relative to discharge capacity than the batteries using an electrolyte (SL) not containing the anion receptor. In particular, batteries using an electrolyte containing the anion receptor compound 1-1 (AR8) in an amount of 0.5% by weight exhibited excellent voltage performance at low temperature (−20° C.).

### Example 15

### Manufacturing of Recycle Battery

(1) Preparation of Waste Batteries

In this embodiment, the module of a waste battery pack recovered from an electric vehicle was disassembled into cells. Among the cells, cells having a discharge capacity of less than 12 Ah (less than 68% compared to the initial capacity) were discharged down to 2.5 V at a rate of 0.5 C. Subsequently, in an inert atmosphere in a dry room or a glove box, a hole was made in each of the cells using a syringe, and the existing waste electrolyte, generated gases, and impurities were removed by vacuum suction through the hole.

(2) Cell Reassembly and Cell Activation

A fresh electrolyte of the present disclosure was injected into each of the cells using a syringe, the holes of the cells were closed, and the cells were aged at a temperature of 25° C. to 30° C. while the cells were shaken sideways, and the cells were charged with a constant current charge (0.1 C rate (2.1A), 4.2 V), followed by a 4.2 V constant voltage charge (0.01 C (0.21 A)).

### Comparative Example 3

### Manufacturing of Recycle Battery

Recycle batteries were prepared in the same manner as in Example 15, except that a non-aqueous electrolyte containing 1M LiPF₆ in EC:EMC:DMC solvent (mixed in a volume ratio of 3:3:4) but not containing any other additives was used.

### Experimental Example 13

### Evaluation of Recycle Battery

As a result of evaluating the constant current discharge capacity of the battery manufactured in Example 15 at a current value of 0.1 C (2.1A) in the range of 3.0 V to 4.2 V using a charging and discharging device, the discharge capacity was recovered from 6.2 Ah to 14.7 Ah.

Meanwhile, as a result of evaluating the battery manufactured in Comparative Example 3, the discharge capacity was increased from 6.2 Ah to 10.1 Ah, but the increase in discharge capacity was not sufficient.

In addition, in order to prevent a problem that the lithium ion battery normally operates until reaching a predetermined temperature (preferably 70° C.) but a fire occurs due to a rapid increase in the temperature of the battery due to thermal runaway, by using the electrolyte of the present disclosure, the present disclosure provides a solid electrolyte that is rapidly cured when the battery temperature reaches or exceeds a predetermined temperature (preferably 130° C.), thereby stopping the operation of the battery in a short time ((for example, within 5 to 10 minutes).

Hereinafter, a method of producing a solidifying electrolyte containing the anion receptor of the present disclosure will be described.

In the case of a solidifying electrolyte, first, the anion acceptor, a crosslinking agent, a curing initiator, and a polymerization inhibitor are added to an electrolyte solution and stirred to prepare a composition mixture solution used to prepare the solidifying electrolyte of the present disclosure as shown in Table 3 below.

Hereinafter, examples of preparing a composition mixture solution for a solidifying electrolyte, and the results of curing experiments will be described in detail.

### Comparative Example 4

### Preparation of Solidifying Electrolyte (1)

The anion receptor compound 1-1 (0.24 g) prepared in Example 1-1 and 6.15 g of triethylene glycol dimethacrylate represented by Formula 16 (purchased from Aldrich), which is a crosslinking agent, were added to and mixed with 60 g of an electrolyte solution (EC:EMC:DMC=3:3:4, LiPF₆ 1 mol/L). To this mixture, 0.01 g of Luperox TBEC (purchased from Aldrich), which is an initiator, was added to prepare a solidifying electrolyte.

### Comparative Example 5

### Preparation of Solidifying Electrolyte (2)

A solidifying electrolyte was prepared by mixing 6.06 g of a crosslinking agent (TEGDA), with the anion receptor compound 1-1, the electrolyte solution, and the initiator in the same amounts as in Comparative Example 3.

### Comparative Example 6

### Preparation of Solidifying Electrolyte (3)

A solidifying electrolyte was prepared by mixing 6.04 g of a crosslinking agent (TEGDA), with the anion receptor compound 1-1, the electrolyte solution, and the initiator in the same amounts as in Comparative Example 3.

### Comparative Example 7

### Preparation of Solidifying Electrolyte (4)

A solidifying electrolyte was prepared by mixing 6.00 g of a crosslinking agent (TEGDA), with the anion receptor compound 1-1, the electrolyte solution, and the initiator in the same amounts as in Comparative Example 3.

### Comparative Example 8

### Preparation of Solidifying Electrolyte (5)

A solidifying electrolyte was prepared by mixing 5.40 g of a crosslinking agent (TEGDA), with the anion receptor compound 1-1, the electrolyte solution, and the initiator in the same amounts as in Comparative Example 3.

### Comparative Example 9

### Preparation of Solidifying Electrolyte (6)

A solidifying electrolyte was prepared by mixing 4.50 g of a crosslinking agent (TEGDA), with the anion receptor compound 1-1, the electrolyte solution, and the initiator in the same amounts as in Comparative Example 3.

### Comparative Example 10

### Preparation of Solidifying Electrolyte (7)

The anion receptor compound 1-1 (0.30 g) prepared in Example 1-1 and 8.40 g of triethylene glycol dimethacrylate represented by Formula 16 (purchased from Aldrich), which is a crosslinking agent, were added to and mixed with 60 g of an electrolyte solution (EC:EMC:DMC=3:3:4, LiPF₆ 1 mol/L). To this mixture, 0.01 g of Luperox TBEC (purchased from Aldrich), which is an initiator, and 1.2 mg of 4-metoxyphenol, which is a polymerization inhibitor, were added to prepare a solidifying electrolyte.

### Example 16

### Preparation of Solidifying Electrolyte (8)

The anion receptor compound 1-1 (0.33 g) prepared in Example 1-1 and 9.23 g of triethylene glycol dimethacrylate represented by Formula 16 (purchased from Aldrich), which is a crosslinking agent, were added to and mixed with 60 g of an electrolyte solution (EC:EMC:DMC=3:3:4, LiPF₆ 1 mol/L). To this mixture, 0.01 g of Luperox TBEC (purchased from Aldrich), which is an initiator, and 1.5 mg of 4-metoxyphenol (purchased from Aldrich), which is a polymerization inhibitor, were added to prepare a solidifying electrolyte.

TABLE 3

| | | Crosslinking | Anion | Additive* | | | |
|---|---|---|---|---|---|---|---|
| | Electrolyte | agent | receptor | total | Total | | Polymerization |
| | (Usage | (Usage | (Usage | (Usage | (Usage | Initiator | inhibitor |
| Classification | g/content %) | g/content %) | g/content %) | g/content %) | g/content %) | Usage g | Usage mg |
| Comparative | 60.00/ | 6.15/ | 2.40/ | 8.55/ | 68.55/ | 0.01 | — |
| Example 4 | 87.53 | 8.97 | 3.50 | 12.47 | 100.00 | | |
| Comparative | 60.00/ | 6.06/ | 2.40/ | 8.46/ | 68.46/ | 0.01 | — |
| Example 5 | 87.65 | 8.85 | 3.50 | 12.36 | 100.00 | | |
| Comparative | 60.00/ | 6.04/ | 2.40/ | 8.44/ | 68.44/ | 0.01 | — |
| Example 6 | 87.67 | 8.83 | 3.50 | 12.33 | 100.00 | | |
| Comparative | 60.00/ | 6.00/ | 2.40/ | 8.40/ | 68.40/ | 0.01 | — |
| Example 7 | 87.72 | 8.77 | 3.51 | 12.28 | 100.00 | | |
| Comparative | 60.00/ | 5.40/ | 2.40/ | 7.80/ | 67.80/ | 0.01 | — |
| Example 8 | 88.50 | 9.96 | 3.54 | 11.50 | 100.00 | | |
| Comparative | 60.00/ | 4.50/ | 2.40/ | 6.90/ | 66.90/ | 0.01 | — |
| Example 9 | 89.70 | 6.73 | 3.59 | 10.30 | 100.00 | | |
| Comparative | 60.00/ | 8.40/ | 0.30/ | 8.70/ | 68.70/ | 0.01 | 1.2 |
| Example 10 | 87.34 | 12.22 | 0.44 | 12.66 | 100.00 | | |
| Example 16 | 60.00/ | 9.23/ | 0.33/ | 9.56/ | 69.56/ | 0.01 | 1.2 |
| | 86.30 | 13.30 | 0.40 | 13.74 | 100.00 | | |

*Additive = Crosslinking agent + Anion receptor

### Experimental Example 14

### Curing Experiment of Solidifying Electrolyte (1)

The solidifying electrolyte solutions prepared in Comparative Examples 4 to 9 were placed in respective 50 ml round flasks, and then observed with the naked eye at 50° C., 70° C., 90° C., 110° C., and 130° C. in a nitrogen atmosphere. The curing time in each flask was measured. The measurement results of Comparative Examples 4 to 9 are shown in Table 4 below.

TABLE 4

| | Temperature/Curing time | | | | |
|---|---|---|---|---|---|
| | 50° C./ | 70° C./ | 90° C./ | 110° C./ | 130° C./ |
| | 120 hours | 48 hours | 12 hours | 1 hour | 5 minutes |
| Comparative | ◯ | ◯ | ◯ | ◯ | ◯ |
| Example 4 | | | | | |
| Comparative | ◯ | ◯ | ◯ | ◯ | ◯ |
| Example 5 | | | | | |
| Comparative | ◯ | ◯ | ◯ | ◯ | ◯ |
| Example 6 | | | | | |
| Comparative | X | X | X | X | X |
| Example 7 | | | | | |
| Comparative | X | X | X | X | X |
| Example 8 | | | | | |
| Comparative | X | X | X | X | X |
| Example 9 | | | | | |

(In the table above, X indicates “not cured” and ◯ indicates “cured”)

As shown in Table 4, in the case of Comparative Examples 4 to 6, the solutions were all cured at a temperature of 50° C. to 130° C. and thus could not be used as a solidifying agent. In addition, in the case of Comparative Examples 7 to 9, the solutions were all cured at a temperature of 50° C. to 130° C. and thus could not be used as a solidifying agent.

As shown in Table 3 above, it can be seen that the total additive content must be at least 12.33% for curing.

### Experimental Example 15

### Curing Experiment of Solidifying Electrolyte (2)

The curing time of the solidifying electrolyte solutions prepared in Comparative Example 10 and Example 16 was measured in the same manner as in Experimental Example 12. The measurement results of Comparative Example 10 and Example 16 are shown in Table 4 below.

TABLE 5

| | Temperature/Curing time | | | | |
|---|---|---|---|---|---|
| | 50° C./ | 70° C./ | 90° C./ | 110° C./ | 130° C./ |
| | 120 hours | 48 hours | 12 hours | 1 hour | 5 minutes |
| Comparative | ◯ | ◯ | ◯ | ◯ | ◯ |
| Example 10 | | | | | |
| Example 16 | X | X | ◯ | ◯ | ◯ |

(In the table above, X indicates “not cured” and ◯ indicates “cured”)

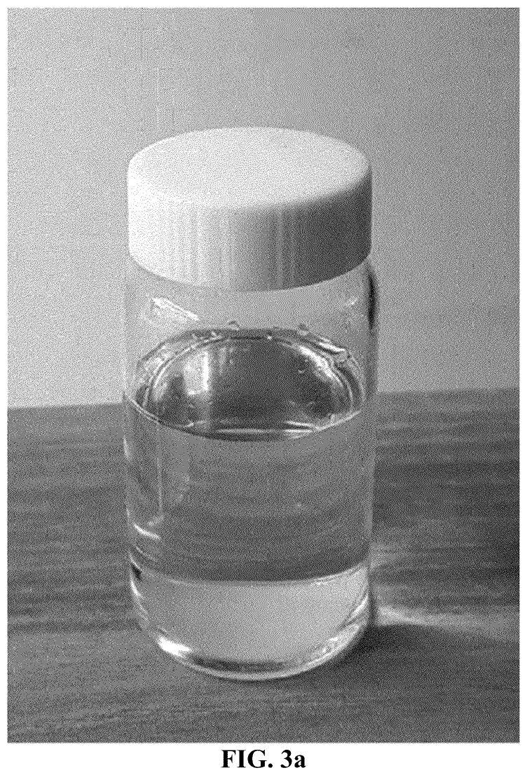

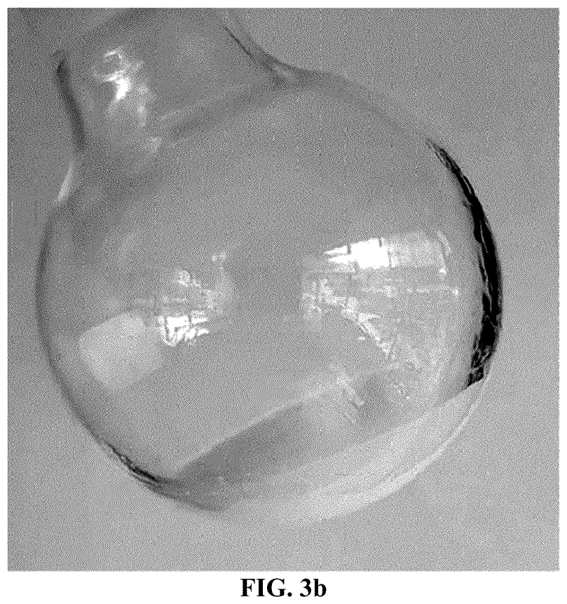

As shown in Table 5 and FIGS. 3A and 3B, in the case of Example 16, the solution was not cured at a temperature of 70° C. or lower and remained as a colorless transparent liquid. However, at a high temperature of 130° C., the solution was cured rapidly within 5 minutes to form a solid. Therefore, this solution can be used as a solidifying agent. Meanwhile, in the case of Comparative Example 10, the solution was cured at a temperature of 70° C. or less. Therefore, the solution cannot be used a solidifying agent.

As shown in Table 3, both the solutions of Example 16 and Comparative Example 10 were added with 1.2 mg of a polymerization inhibitor. Like in Example 16 in which the total content of additives is at least 13.74%, the solution is not cured at a low temperature of 70° C. or lower, and thus it can be used as a solidifying agent.

As described above, the liquid electrolyte using the novel anion receptor compound according to one of the examples as an additive can provide an electrolyte with improved lithium cycling performance and efficiency, and can be used as an electrolyte additive for a high-capacity lithium ion battery. In addition, the solid polymer electrolyte containing the novel anion receptor compound according to one of the examples can provide an electrolyte with significantly improved ionic conductivity and electrochemical stability at room temperature, and can provide a solid polymer electrolyte that is rapidly cured within 5 minutes when the temperature reaches or exceeds a certain temperature (about 130° C.) to stop the operation of the battery, thereby preventing rapid temperature rise due to thermal runaway and preventing the risk of fire due to the rapid temperature rise.

Embodiments of the present disclosure can provide a novel anion receptor that improves the ionic conductivity and cation transport rate of an electrolyte and improves the electrochemical stability of an alkaline metal battery using the electrolyte and can provide a non-aqueous liquid electrolyte containing the novel anion receptor, and a gel-type or solid polymer electrolyte containing the novel anion receptor.

According to one embodiment of the present disclosure, the present disclosure can provide a novel anion receptor compound and can provide an electrolyte (or polymer electrolyte) with significantly improved ionic conductivity and electrochemical stability at room temperature by utilizing the novel anion receptor.

According to one embodiment of the present disclosure, the present disclosure can provide a recycle battery by replacing a waste electrolyte in a waste lithium secondary battery used as an electric vehicle battery with an electrolyte containing the anion receptor.

As described above, although the embodiments have been described with reference to a limited number of examples and drawings, various modifications and variations can be made by those skilled in the art with reference to the above description. For example, even though the described techniques are performed in a different order than the described method, and/or the described components are coupled or combined in a different form than the described method or are replaced or substituted by other components or equivalents, adequate results can be achieved. Therefore, other embodiments, other examples, and equivalents to the claims also fall within the scope of the claims described below.

1. A compound as a novel anion receptor, the compound being represented by any one of Formulas 1 to 3: 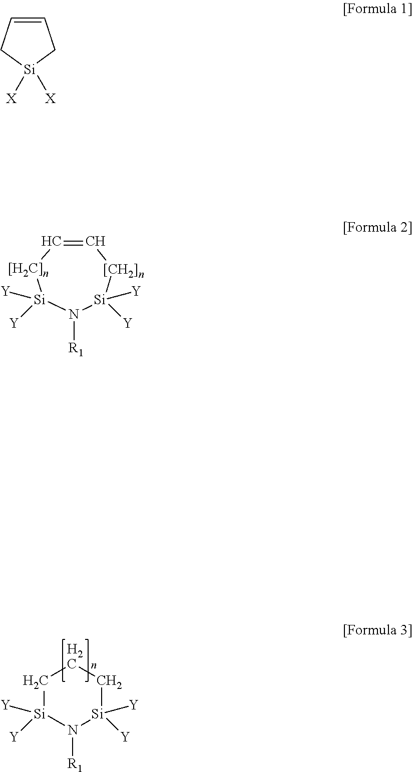
(In Formula 1,
X is selected from 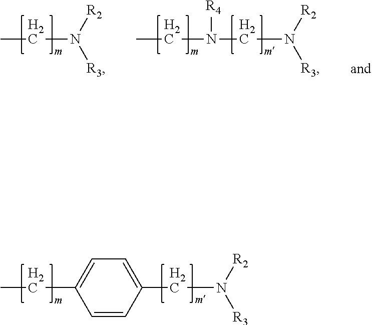
(R₂, R₃, and R₄ are each selected from a hydrogen atom, a halogen atom, and an electron withdrawing functional group that is selected from —SO₂CF₃, —COCF₃, —SO₂CN, —CF₃, and —CN; m and m′ are each independently an integer in a range of from 0 to 20; and there is no case where R₂, R₃, and R₄ are all a hydrogen atom at the same time),
Y is selected from a hydrogen atom, a halogen atom, linear or branched alkyl groups having 1 to 20 carbon atoms, linear or branched alkenyl groups having 2 to 20 carbon atoms, linear or branched alkynyl groups having 2 to 20 carbon atoms, —COR (R is a linear or branched alkyl group having 1 to 20 carbon atoms or a linear or branched alkenyl group having 2 to 20 carbon atoms), —OR (R is a linear or branched alkyl group having 1 to 20 carbon atoms), —ROR′ (R and R′ are each independently a linear or branched alkyl group having 1 to 20 carbon atoms), —Si(R)₃ (R is a linear or branched alkyl group having 1 to 20 carbon atoms), —O—Si(R)₃ (R is a linear or branched alkyl group having 1 to 20 carbon atoms), 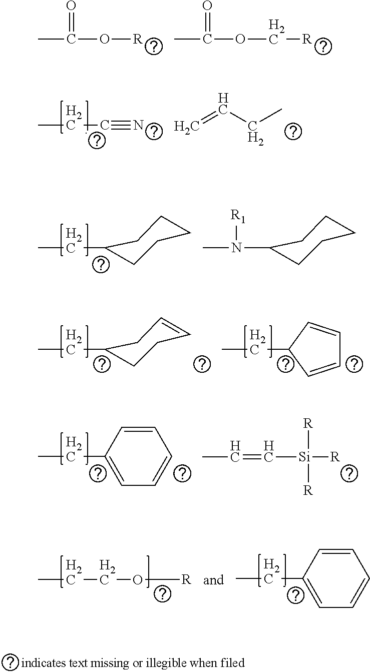
(wherein R and R₁ are each selected from linear or branched alkyl groups having 1 to 20 carbon atoms and linear or branched alkenyl groups having 2 to 20 carbon atoms; R₁ is selected from a halogen atom and an electron withdrawing functional group that is selected from —SO2CF3, —COCF3, —SO2CN, —CF3, and —CN; and 1 is an integer in a range of from 0 to 20),
R₁ is selected from a halogen atom and an electron withdrawing functional group that is selected from —SO₂CF₃, —COCF₃, —SO₂CN, —CF₃, and —CN, and
n is an integer in a range of from 0 to 20).

2. The compound of claim 1, wherein
R₁ is selected from —SO₂CF₃, —COCF₃, and —CF₃,
R₂, R₃, and R₄ are each selected from a hydrogen atom, a halogen atom, and an electron withdrawing functional group that is selected from —SO₂CF₃, —COCF₃, and —CF₃; there is no case where R₂, R₃, and R₄ are all a hydrogen atom at the same time; m and m′ are each independently an integer in a range of from 0 to 20;
Y is selected from —F, —CH₃, —CH₂CH₃, —CH═CH₂, —CO—CH═CH₂, —OCH₃, —CH₂OCH₃, —OCH₂CH₃, —CH(CH₃)₂, —O—CH(CH₃)₂, —C(CH₃)₃, —Si(CH₃)₃, —O—Si(CH₃)₃, 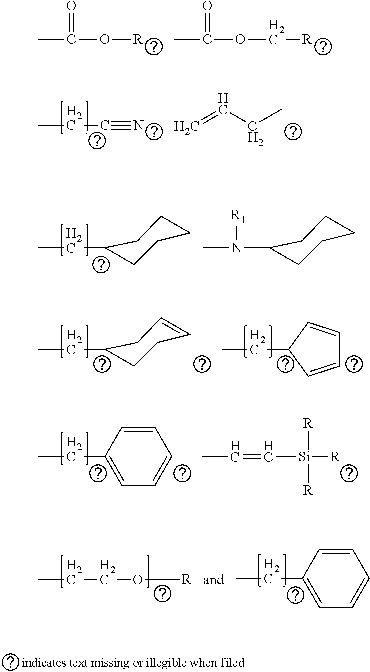
(wherein R is selected from linear or branched alkyl groups having 1 to 5 carbon atoms, R₁ is selected from a halogen atom and an electron withdrawing functional group that is selected from —SO₂CF₃, —COCF₃, and —CF₃; and 1 is an integer in a range of from 0 to 10),
n is an integer in a range of from 0 to 20.

3. The compound of claim 1, wherein the compound is selected from the following compounds: 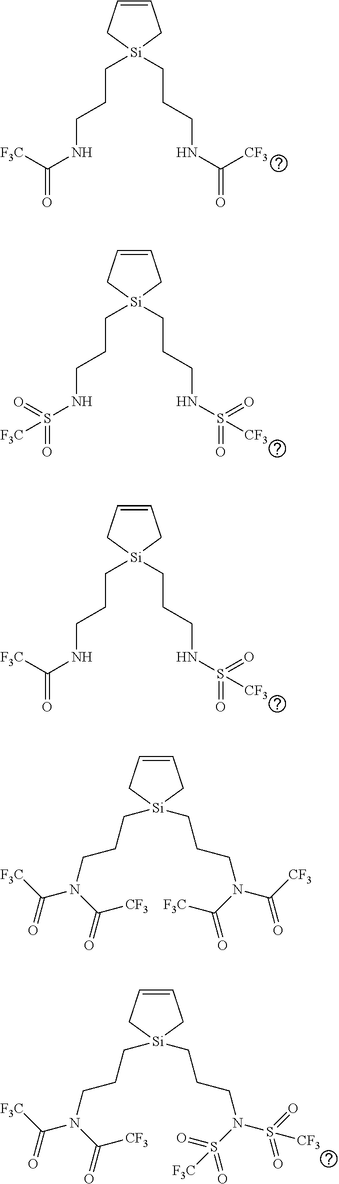 [SMILES: O=C(NCCC[Si]1(CCCNC(=O)C(F)(F)F)CC=CC1)C(F)(F)F ; O=S(=O)(NCCC[Si]1(CCCNS(=O)(=O)C(F)(F)F)CC=CC1)C(F)(F)F ; O=C(NCCC[Si]1(CCCNS(=O)(=O)C(F)(F)F)CC=CC1)C(F)(F)F ; O=C(N(CCC[Si]1(CCCN(C(=O)C(F)(F)F)C(=O)C(F)(F)F)CC=CC1)C(=O)C(F)(F)F)C(F)(F)F ; O=C(N(CCC[Si]1(CCCN(S(=O)(=O)C(F)(F)F)S(=O)(=O)C(F)(F)F)CC=CC1)C(=O)C(F)(F)F)C(F)(F)F] 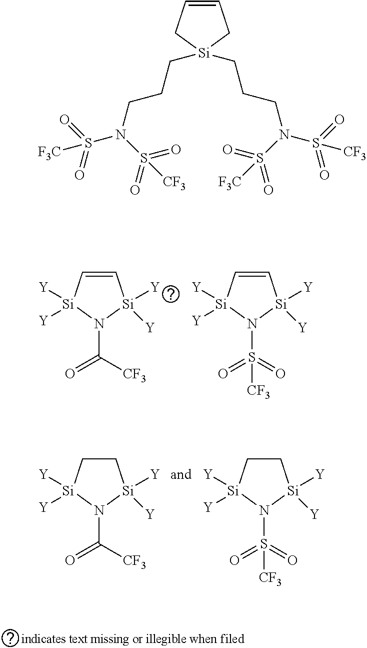
(Y is selected from —F, —CH₃, —CH₂CH₃, and —CH═CH₂).

4. An electrolyte composition comprising an anion receptor comprising at least one of the compounds represented by Formulas 1 to 3 recited in claim 1.

5. The electrolyte composition of claim 4, wherein the anion receptor is contained in an amount of 0.01% to 40% by weight with respect to the total amount of the electrolyte composition.

6. The electrolyte composition of claim 4, further comprising:
an electrolyte salt containing an alkali metal ion; and
a non-aqueous solvent.

7. The electrolyte composition of claim 4, further comprising a crosslinkable polymeric compound, wherein the crosslinkable polymeric compound is contained in an amount of 20% to 90% by weight with respect to the total amount of the electrolyte composition.

8. The electrolyte composition of claim 4, further comprising a polymerization inhibitor, in which the polymerization inhibitor is contained in an amount of 0.01% to 3% by weight with respect to the total weight of the electrolyte composition.

9. The electrolyte composition of claim 4, wherein the electrolyte composition forms a liquid, gel-type, or solid electrolyte.

10. The electrolyte composition of claim 4, further comprising at least one among compounds represented by Formulas 4 to 13 shown below: 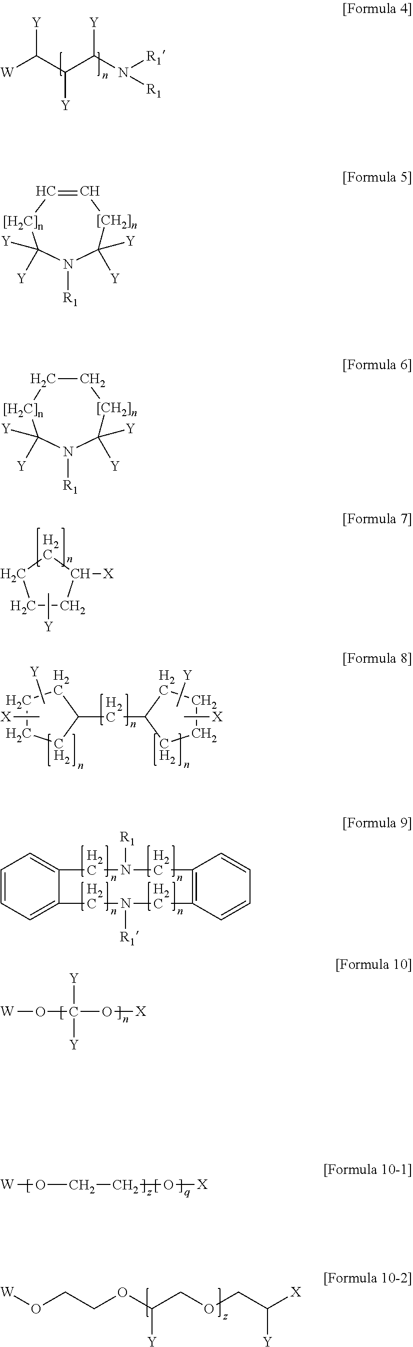 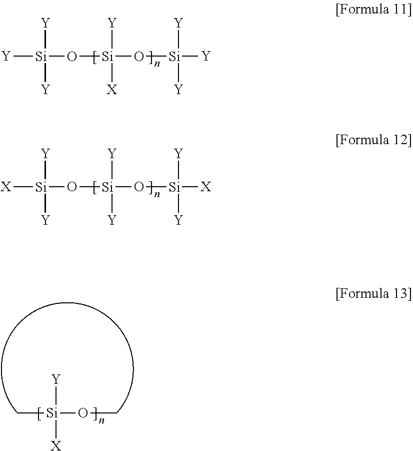
(In Formulas 4 to 13,
X is selected from 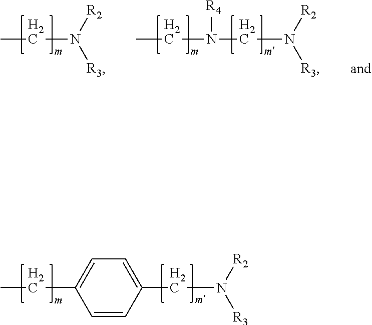
(R₂, R₃, and R₄ are each selected from a hydrogen atom, a halogen atom, and an electron withdrawing functional group that is selected from —SO₂CF₃, —COCF₃, —SO₂CN, —CF₃, and —CN; m and m′ are each independently an integer in a range of from 0 to 20; and there is no case where R₂, R₃, and R₄ are all a hydrogen atom at the same time),
Y is selected from a hydrogen atom, a halogen atom, linear or branched alkyl groups having 1 to 20 carbon atoms, linear or branched alkenyl groups having 2 to 20 carbon atoms, linear or branched alkynyl groups having 2 to 20 carbon atoms, —COR (R is a linear or branched alkyl group having 1 to 20 carbon atoms or a linear or branched alkenyl group having 2 to 20 carbon atoms), —OR (R is a linear or branched alkyl group having 1 to 20 carbon atoms), —ROR′ (R and R′ are each independently a linear or branched alkyl group having 1 to 20 carbon atoms), —Si(R)₃ (R is a linear or branched alkyl group having 1 to 20 carbon atoms), —O—Si(R)₃ (R is a linear or branched alkyl group having 1 to 20 carbon atoms), 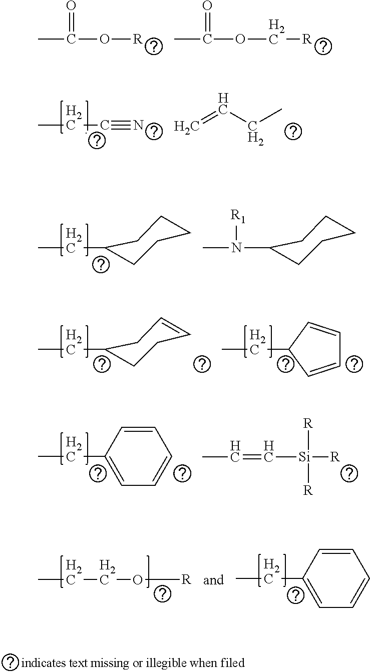
(wherein, R is selected from linear or branched alkyl groups having 1 to 20 carbon atoms and linear or branched alkenyl groups having 2 to 20 carbon atoms; Ri is selected from a halogen atom and an electron withdrawing functional group that is selected from —SO₂CF₃, —COCF₃, —SO₂CN, —CF₃, and —CN; and I is an integer in a range of from 0 to 20),
R₁ and R₁′ are each selected from a hydrogen atom and electron withdrawing functional groups selected from —SO₂CF₃, —COCF₃, —SO₂CN, —CF₃, and —CN, wherein there is no case where R₁ and R₁′ are both a hydrogen atom at the same time in the same molecule,
W is selected from a hydrogen atom, a halogen atom, linear or branched alkyl groups having 1 to 20 carbon atoms, linear or branched alkenyl groups having 2 to 20 carbon atoms, linear or branched alkynyl groups having 2 to 20 carbon atoms, 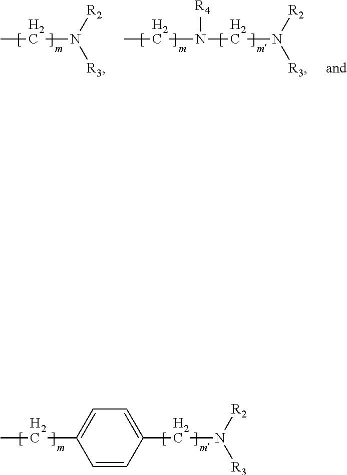
(R₂, R₃, and R₄ are each selected from a hydrogen atom, a halogen atom, and an electron withdrawing functional group that is selected from —SO₂CF₃, —COCF₃, —SO₂CN, —CF₃, and —CN, wherein there is no case where R₂, R₃, and R₄ are all a hydrogen atom at the same time, wherein m and m′ are each independently an integer in a range of from 0 to 20), and
z is an integer in a range of from 1 to 20,

11. The electrolyte composition of claim 10, wherein at least one of the compounds represented by Formulas 4 to 13 accounts for 0.01% to 50% by weight with respect to the total weight of the anion receptor.

12. An electrolyte prepared from the electrolyte composition of claim 4.

13. The electrolyte of claim 12, wherein the electrolyte is a non-aqueous liquid electrolyte, a gel-type polymer electrolyte, or a solid polymer electrolyte.

14. A solidifying electrolyte prepared from the electrolyte composition of claim 4.

15. A polymer electrolyte membrane prepared from the electrolyte composition of claim 4.

16. A battery comprising an anode, a cathode, and an electrolyte prepared from the electrolyte composition of claim 4.

17. A recycle battery comprising an anode recovered from a waste battery, a cathode recovered from a waste battery, and an electrolyte prepared from the electrolyte composition of claim 4.
